(19) United States
(12) Patent Application Publication
(10) Pub. No.: US 2024/0417605 A1
(43) Pub. Date: Dec. 19, 2024

(54) EPOXY STRUCTURAL ADHESIVES RESISTANT TO UNCURED AND CURED HUMIDITY EXPOSURE

(71) Applicant: Henkel AG & Co. KGaA, Duesseldorf (DE)

(72) Inventors: Bryan James Siegert, Lake Orion, MI (US); Nicholas Thomas Kamar, Trenton, MI (US); Syed Z. Mahdi, Rochester Hills, MI (US); Erica Elizabeth Gibbons, Clay Township, MI (US); Alfred A. DeCato, Highland, MI (US); Ronald F. Dubs, Oxford, MI (US)

(21) Appl. No.: 18/813,879

(22) Filed: Aug. 23, 2024

Related U.S. Application Data
(63) Continuation of application No. PCT/US2023/063037, filed on Feb. 22, 2023.
(60) Provisional application No. 63/316,148, filed on Mar. 3, 2022.

(51) Int. Cl. C09J 163/00; C08K 3/22; C08K 3/26; C08K 3/36; C08K 5/21; C08K 5/315; C08K 5/49; C09J 5/02; C09J 7/35

(52) U.S. Cl. CPC C09J 163/00; C08K 3/22; C08K 3/36; C08K 5/21; C08K 5/3155; C08K 5/49; C09J 5/02; C09J 7/35; C08K 2003/2206; C08K 2003/265; C09J 2400/166; C09J 2409/00

(57) ABSTRACT

Epoxy-based adhesive compositions are provided, exhibiting improved uncured humidity resistance, cured humidity resistance and improved wash-off resistance, which upon curing result in crash durable and stress resistant cured bonds on steel and low surface tension surfaces, e.g. ZnMgAl, hot dipped galvanized (HDG) and treated aluminum surfaces. Also provided are bonded assemblies comprising pre-cure or fully cured epoxy-based adhesives, methods of making the epoxy-based adhesives, methods of bonding assemblies and articles of manufacture comprising the bonded assemblies.

### TECHNICAL FIELD

This invention relates to epoxy-based fracture toughened adhesive compositions exhibiting improved uncured humidity resistance, pre-cured humidity resistance, cured humidity resistance and improved wash-off resistance, which upon curing result in crash durable and stress resistant cured bonds on steel and low surface tension surfaces, e.g. ZnMgAl, hot dipped galvanized (HDG) and treated aluminum surfaces Also provided are bonded assemblies comprising uncured, pre-cured or fully cured epoxy-based adhesives, methods of making the epoxy-based adhesives, methods of bonding assemblies and articles of manufacture comprising the bonded assemblies.

### BACKGROUND

Automotive original equipment manufacturers (OEMs) require crash durable structural adhesive compositions having cured adhesion and bond durability suitable for use in vehicle assembly. Structural epoxy based one component adhesives are widely used in automotive manufacturing. Challenges in performance of these fracture toughened adhesive compositions include adhesion to low surface tension & oily surfaces, resistance to wash-off, while maintaining impact resistance and lap shear strength after uncured humidity exposure as well as aging of partially cured adhesives in assemblies under humid conditions that are subsequently fully cured. OEMs expect that a single formulation exhibits ‘good adhesion’ on various metallic substrates.

In the automotive industry, for some bonding applications there is a requirement that the adhesives resist humid environmental conditions in the uncured stage. Poor humidity resistance can compromise the cured adhesive strength performance (i.e., higher loss of strength) and/or its failure mode to the substrate (i.e., less cohesive and more adhesive failure, bubbles in the adhesive layer caused by degassing water when adhesive is curing in the e-coat oven). There are a variety of common manufacturing situations where extended exposure to humid conditions prior to cure exist. For example, automotive OEMs make some components or modular parts with uncured adhesive and after an extended time period, then complete assembly and cure, optionally at a separate facility, which is referred to herein as “complete knock down assembly” (CKD). While the “complete knock down” assembly method provides logistical benefits, during storage and/or transport of the part or assembly, the pre-cured or partially cured structural adhesive can be exposed to significant quantities of moisture prior to the secondary cure.

A drawback of some crash durable structural adhesive compositions has been moisture absorption in the ‘partially cured’ epoxy polymer adhesives negatively affecting one or more of glass transition temperature (T_{g}), bulk mechanical properties, adhesion, and durability. In particular, testing revealed that crash durable structural adhesives subjected to humidity exposure after an initial ‘pre-curing’, sometimes referred to as ‘partial’ or ‘pre-drying’ cure followed by a secondary, ‘nominal bake’ cure, showed interfacial failure, which is unacceptable for most OEM uses. This failure was not predictable based on performance profiles of fully cured adhesives exposed to humidity after full cure.

For these, and any other, manufacturing situations where there is an extended time period between application and cure of a one component epoxy adhesive, it would be desirable to have an adhesive technology wherein the bulk adhesive demonstrates an increase in resistance to humidity, e.g. humidity resistance of uncured or pre-cured adhesive applied to a surface, such that the later fully cured adhesive retains adhesion and bond durability performance. It is also desirable to provide crash durable adhesives having both uncured, open bead humidity resistance and wash-off resistance. A need also exists for a single package adhesive composition that exhibits environmental stress durability particularly after low bake curing conditions, as well as improved uncured humidity resistance exhibited by high T-peel strength and impact wedge peel strength in the cured state after exposure to humid conditions in the uncured state. There is a constant need for new and improved adhesives that meet these requirements. The present disclosure addresses at least some of these needs.

### SUMMARY

Applicants have discovered that unexpectedly improved liquid adhesive formulations can be prepared by mixing epoxy resins, one or more carboxyl-terminated butadiene homopolymer (CTB) and/or carboxyl-terminated butadiene acrylonitrile copolymer (CTBN), rubber particles (preferably having a core-shell structure and/or an average particle size of less than 500 nm), at least one latent curing agent capable of being activated by heating; at least one accelerator different from the curing agent; at least one flexibilizer and at least one additive which may comprise one or more of or be selected from the group consisting of: at least one plasticizer (e.g., sulfonate plasticizers, phosphate ester plasticizers), polyurethane toughening agents, diluents, flame retardants, chelate modified epoxy resin, auxiliary impact modifiers/toughening agents, fillers, organic and/or inorganic thixotropic agents (such as fumed silica, mixed mineral phyllosilicates, organic thixotropic agents) optionally surface modified, viscosity/rheology modifiers or other adjuvants.

The present invention is a toughened one component epoxy adhesive composition demonstrating improved resistance to humidity. In one embodiment, the one-part structural adhesive of the present invention comprises, consists essentially of, consists of:
an epoxy resin component comprising a solid epoxy resin, a liquid epoxy resin, or mixture thereof;
one or more carboxyl-terminated butadiene homopolymer (CTB), carboxyl-terminated butadiene acrylonitrile copolymer (CTBN) and combinations thereof;
rubber particles (preferably having a core-shell structure and/or an average particle size of less than 500 nm);
one or more latent curing agent capable of being activated by heating;
one or more accelerator different from the curing agent;
one or more inorganic filler;
one or more flexibilizers; and
and at least one additive which may comprise one or more of or be selected from the group consisting of: at least one plasticizer (e.g., sulfonate plasticizers, phosphate ester plasticizers), polyurethane toughening agents, diluents, flame retardants, chelate modified epoxy resin, auxiliary impact modifiers/toughening agents, organic fillers, organic-inorganic fillers, organic and/or inorganic thixotropic agents (such as fumed silica, mixed mineral phyllosilicates, cellulose, guar gum, waxes etc.) optionally surface modified, viscosity/rheology modifiers, colorant or other adjuvants.

When applied to a substrate or carrier and cured by heating, the adhesive results in a product capable of forming bonds with improved lap shear strength in the cured state even after exposure to humidity in the uncured state or in a two-step cure process, e.g. CKD. A particular benefit of some embodiments is a single formulation exhibiting good adhesion to steel and aluminum substrates; this ability to adhere to both types of metal increases manufacturing flexibility in the body shop such that only a single adhesive is required at a pumping station.

Applicants have developed various structural adhesives useful in “complete knock down” assembly methods, including formulations according to the invention used in “complete knock down” assembly exposed lap shear specimens which exhibit desired cohesive failure mode after “complete knock down” assembly exposure with good retention of adhesion properties. According to some embodiments, formulations according to the invention also provide significant improvements in both uncured, open bead humidity resistance and wash-off resistance. Structural adhesives according to some embodiments of the invention also exhibit good adhesion to low surface tension substrates such as zinc magnesium aluminum (ZnMgAl) and hot dipped galvanized (HDG) steels, in addition to treated aluminum substrates. Furthermore, since the structural adhesive com-positions exhibit good oil uptake and wetting on HDG steels and other metals the wash-off resistance is synergistically improved. Some embodiments include one or more thixotropic agents, preferably hydrophobic, optionally surface modified, which were found to increase uncured adhesive yield stress, without negative influence on adhesion or impact properties.

For a variety of reasons, it is preferred that compositions, uncured adhesive, pre-cured adhesive and cured adhesive, and articles of manufacture disclosed herein may be made in the absence of certain ingredients, i.e. be free of certain materials, whether added or generated in situ, other than minor amounts of contaminants; or may be substantially free from certain ingredients used for similar purposes in the prior art. Specifically, it is increasingly preferred in the order given, independently for each preferably minimized ingredient listed below, that at least some embodiments of according to the invention contain no more than 1.0, 0.5, 0.35, 0.10, 0.08, 0.04, 0.02, 0.01, 0.001, or 0.0002 percent, more preferably said numerical values in grams per liter, more preferably said numerical values in ppm, of each of the following constituents: Bisphenol A, halogenated epoxy resins, copper, gold, silver, oxidizing agents such as peroxides and peroxyacids, permanganate, perchlorate, chlorate, chlorite, hypochlorite, perborate, hexavalent chromium, sulfuric acid and sulfate, nitric acid and nitrate ions; as well as fluorine, formaldehyde, formamide, hydroxylamines, cyanides, cyanates; rare earth metals; boron, e.g. borax, borate; strontium; and/or free halogen ions, e.g., fluoride, chloride, bromide or iodide.

The disclosure is directed to new compositions of matter, including those comprising liquid epoxy-based adhesives that upon cure provide crash durable and stress resistant cured bonds useful in adhering substrates, e.g. metal substrates, together, also provided are bonded assemblies derived by applying the uncured adhesive to one or both of the substrates to be bonded, bringing the substrates into contact such that the adhesive is located between the substrates to be bonded and curing the adhesive, and methods of making these liquid epoxy-based adhesives, methods of bonding substrates and articles of manufacture comprising the bonded assemblies. The epoxy-based adhesive compositions retain cured bond strength even when the uncured liquid epoxy-based composition is subjected to humidity exposure before curing. In some embodiments the compositions are weldable in an uncured state. Various embodiments of the invention are described throughout this disclosure, including:

Embodiment 1. A liquid epoxy adhesive composition comprising:
(a) at least one epoxy resin;
(b) one or more carboxyl-terminated butadiene rubbers;
(c) rubber particles, preferably core-shell rubber particles and/or particles having a particle size of less than 500 nm;
(d) optionally, one or more blocked polyurethane toughening agents wherein the one or more blocked polyurethane toughening agents comprises at least one asymmetrically end-capped polyurethane;
(e) at least one heat-activated latent curing agent preferably comprising DICY;
(f) at least one accelerator different from the curing agent;
wherein (b) comprises at least one carboxyl-terminated butadiene homopolymer (CTB) and at least one carboxyl-terminated butadiene acrylonitrile copolymer (CTBN).

The epoxy adhesive can further contain other additives such as flame retardants, polyetheramine flexibilizers, fillers, coupling agents, plasticizers, diluents, extenders, pigments and dyes, thixotropic agents, expanding agents, flow control agents, adhesion promoters and antioxidants. In certain Aspects of this Embodiment, the liquid epoxy adhesive composition is free of formaldehyde.

Embodiment 2. The liquid epoxy adhesive composition of Embodiment 1 further characterized in that said components are or comprise:
(a) one or more diglycidyl ether of a bisphenol-A (DGEBA) epoxy resins or bisphenol-F (DGEBF) epoxy resins, desirably present in a range of from 20 wt. % to 80 wt. %;
(b) at least two selected from a carboxyl-terminated butadiene homopolymer (CTB)-epoxy adducts, a carboxyl-terminated butadiene acrylonitrile copolymer (CTBN)-epoxy adduct, or an adduct of carboxyl-terminated butadiene homopolymer (CTB) and carboxyl-terminated butadiene acrylonitrile copolymer (CTBN) and epoxy, desirably each independently present in a range of from 1 wt. % to 30 wt. %;
(c) core shell rubber (CSR) particles, desirably present in a range of from 5 wt. % to 40 wt. %;
(d) optionally one or more blocked polyurethane toughening agents, desirably present in a range of from 0 wt. % to 20 wt. %;
(e) one or more dicyandiamides (DICY), desirably present in a range of from 2 wt. % to 7 wt. %;
(f) one or more urea-based accelerator, desirably present in a range of from 0.3 wt. % to 2.0 wt. %;
(g) one or more filler, desirably present in a range of from 0 wt. % to 35 wt. %;
(h) one or more phenol novolac epoxies, desirably present in a range of from 1 wt. % to 20 wt. %;
(i) one or more flame retardants, desirably present in a range of from 0 wt. % to 35 wt. %;
(j) one or more polyetheramine flexibilizer, desirably present in a range of from 3 wt. % to 30 wt. %; and
(k) one or more thixotropic agents, desirably present in a range of from 0 wt. % to 25 wt. %;
wherein the wt. % of each component is relative to the total weight of the composition and the total amount of the components does not exceed 100 wt. %.

Embodiment 3. The liquid epoxy adhesive composition of Embodiment 1 or 2, wherein (a) the one or more diglycidyl ether of the bisphenol-A (DGEBA) epoxy resin or bisphenol-F (DGEBF) epoxy resin is present in a range of from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. % from 70 wt. % to 75 wt. %, from 75 wt. % to 80 wt. % or any combination of two or more of the foregoing ranges, for example from 25 wt. % to 55 wt. %, or any of the foregoing values, relative to the total weight of the composition.

Embodiment 4. The liquid epoxy adhesive composition of any one of Embodiments 1 to 3, wherein (b) at least one carboxyl-terminated butadiene homopolymer (CTB) and at least one carboxyl-terminated butadiene acrylonitrile copolymer (CTBN), desirably present as adducts of DGEBA and/or DGEBF is each independently present in a range of from 1 wt. % to 1.1 wt. %, from 1.1 wt. % to 1.2 wt. %, from 1.2 wt. % to 1.3 wt. %, from 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, from 8 wt. % to 8.5 wt. %, from 8.5 wt. % to 9 wt. % from 9 wt. % to 9.5 wt. %, from 9.5 wt. % to 10 wt. % from 10 wt. % to 10.5 wt. %, from 10.5 wt. % to 11 wt. % from 11 wt. % to 11.5 wt. %, from 11.5 wt. % to 12 wt. %, from 12 wt. % to 12.5 wt. %, from 12.5 wt. % to 13 wt. % from 13 wt. % to 13.5 wt. %, from 13.5 wt. % to 14 wt. % from 14 wt. % to 14.5 wt. %, from 14.5 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. % or any combination of two or more of the foregoing ranges, for example from 1.3 wt. % to 1.6 wt. %, or any of the foregoing values, calculated based on amounts of homopolymer, copolymer and adducts if present, relative to the total weight of the composition;

Embodiment 5. The liquid epoxy adhesive composition of any one of Embodiments 1 to 4, wherein (c) the core shell rubber (CSR) particles are present in a range of from 5 wt. % to 6 wt. % from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 21 wt. %, from 21 wt. % to 22 wt. %, from 22 wt. % to 23 wt. %, from 23 wt. % to 24 wt. %, from 24 wt. % to 25 wt. %, from 25 wt. % to 26 wt. %, from 26 wt. % to 27 wt. %, from 27 wt. % to 28 wt. %, from 28 wt. % to 29 wt. %, from 29 wt. % to 30 wt. %, or any combination of two or more of the foregoing ranges, for example from 10 wt. % to 15 wt. %, or any of the foregoing values, measured as CSR solids, relative to the total weight of the composition;

Embodiment 6. The liquid epoxy adhesive composition of any one of Embodiments 1 to 5, wherein (d) the optional one or more blocked polyurethane toughening agent is present in a range of from 0 wt. % to 1 wt. %, from 1 wt. % to 2 wt. %, from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, or any combination of two or more of the foregoing ranges, for example from 1 wt. % to 15 wt. % or 5 wt. % to 7 wt. %, or any of the foregoing values, relative to the total weight of the composition;

Embodiment 7. The liquid epoxy adhesive composition of any one of Embodiments 1 to 6, wherein (e) the at least one heat-activated latent curing agent comprising DICY, wherein the one or more dicyandiamide (DICY) is present in a range of from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, 6.5 wt. % to 7 wt. %, from 7 wt. % to 7.5 wt. % or any combination of two or more of the foregoing ranges, for example from 3 wt. % to 4 wt. %, or any of the foregoing values, relative to the total weight of the composition;

Embodiment 8. The liquid epoxy adhesive composition of any one of Embodiments 1 to 7, wherein (f) the at least one accelerator different from the curing agent; such as one or more urea-based accelerators, e.g. a substituted urea accelerator is present in a range of from 0.1 wt. % to 0.2 wt. %, from 0.2 wt. % to 0.3 wt. %, from 0.3 wt. % to 0.4 wt. %, from 0.4 wt. % to 0.5 wt. %, from 0.5 wt. % to 0.6 wt. % to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, from 1.2 wt. % to 1.3 wt. %, 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2.0 wt. %, from 2.0 wt. % to 2.1 wt. %, from 2.1 wt. % to 2.2 wt. %, from 2.2 wt. % to 2.4 wt. %, from 2.4 wt. % to 2.5 wt. %, or any combination of two or more of the foregoing ranges, for example from 0.5 wt. % to 1 wt. %, or any of the foregoing values, relative to the total weight of the composition;

Embodiment 9. The liquid epoxy adhesive composition of any one of Embodiments 1 to 8, wherein (g) one or more filler are present in a range of from 1 wt. % to 2 wt. % from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 22 wt. %, from 22 wt. % to 24 wt. %, from 24 wt. % to 26 wt. %, from 26 wt. % to 28 wt. %, from 28 wt. % to 30 wt. %, from 30 wt. % to 35 wt. %, or any combination of two or more of the foregoing ranges, for example from 5 wt. % to 17 wt. %, or any of the foregoing values, relative to the total weight of the composition. The filler may be one or more organic or one or more inorganic or a combination of one or more organic and one or more inorganic fillers;

Embodiment 10. The liquid epoxy adhesive composition of any one of Embodiments 1 to 9, wherein (h) the one or more phenol novolac epoxy is present in a range of from 1 wt. % to 1.5 wt. %, from 1.5 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, from 8 wt. % to 8.5 wt. %, from 8.5 wt. % to 9 wt. %, from 9 wt. % to 9.5 wt. %, from 9.5 wt. % to 10 wt. %, 10 wt. % to 12 wt. %, from 12 wt. % to 14 wt. %, from 14 wt. % to 16 wt. %, from 16 wt. % to 20 wt. %, or any combination of two or more of the foregoing ranges, for example from 4.5 wt. % to 6.5 wt. % or from 4.5 wt. % to 9 wt. %, or any of the foregoing values, relative to the total weight of the composition.

Embodiment 11. The liquid epoxy adhesive composition of any one of Embodiments 1 to 10, wherein (i) the one or more flame retardant is present in a range of from 0 wt. % to 1 wt. %, 1 wt. % to 2 wt. %, from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 22 wt. %, from 22 wt. % to 24 wt. %, from 24 wt. % to 26 wt. %, from 26 wt. % to 28 wt. %, from 28 wt. % to 30 wt. %, from 30 wt. % to 35 wt. %, or any combination of two or more of the foregoing ranges, for example from 2 wt. % to 16 wt. %, or any of the foregoing values, relative to the total weight of the composition;

Embodiment 12. The liquid epoxy adhesive composition of any one of Embodiments 1 to 11, wherein (j) one or more polyetheramine flexibilizer is present in a range of from 0 wt. % to 1 wt. %, from 1 wt. % to 1.5 wt. %, from 1.5 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, from 8 wt. % to 8.5 wt. %, from 8.5 wt. % to 9 wt. %, from 9 wt. % to 9.5 wt. %, from 9.5 wt. % to 10 wt. %, from 10 wt. % to 10.5 wt. %, from 10.5 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 22 wt. %, from 22 wt. % to 24 wt. %, from 24 wt. % to 26 wt. %, from 26 wt. % to 28 wt. %, from 28 wt. % to 30 wt. %, from 30 wt. % to 35 wt. % or any combination of two or more of the foregoing ranges, for example from 1.5 wt. % to 10 wt. %, or any of the foregoing values, relative to the total weight of the composition.

Embodiment 13. The liquid epoxy adhesive composition of any one of Embodiments 1 to 12, wherein (k) one or more thixotropic agents is present in a range of from 0 wt. % to 1 wt. %, from 1 wt. % to 2 wt. % from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 22 wt. %, from 22 wt. % to 24 wt. %, from 24 wt. % to 26 wt. %, or any combination of two or more of the foregoing ranges, for example from 0 wt. % to 2 wt. %, or any of the foregoing values, relative to the total weight of the composition.

Embodiment 14. The liquid epoxy adhesive composition of any one of Embodiments 1 to 13, wherein the one or more diglycidyl ether of the bisphenol-A (DGEBA) epoxy resin or bisphenol-F (DGEBF) epoxy resin comprises one or more of a diglycidyl ether of a bisphenol-A (DGEBA) epoxy resin. In other Aspects of this Embodiment, the one or more diglycidyl ether comprises two or more of DGEBA and may further comprise a diglycidyl ether of a bisphenol-F (DGEBF) epoxy resin. In some Aspects of this Embodiment, the diglycidyl ether includes at least one liquid (at 23° C.) diglycidyl ether of bisphenol A, of bisphenol F, or of both bisphenol A and bisphenol F. Such an epoxy resin may further include at least one solid (at 23° C.) diglycidyl ether of bisphenol A and/or of bisphenol F. Such an epoxy resin mixture may contain up to 5% monohydrolyzed species that are present as impurities in one or more of the constituent resins.

Embodiment 15. The liquid epoxy adhesive composition of any one of Embodiments 1 to 14, wherein the one or more of diglycidyl ether of the bisphenol-A (DGEBA) epoxy resin has an Epoxy Equivalent Weight (EEW) in a range of from 180 to 195, preferably from 185 to 192, where

$$EEW = \frac{MW epoxy resin}{Number ( \# ) of epoxy groups} .$$

In other Aspects of this Embodiment, the one or more of diglycidyl ether of the bisphenol-A (DGEBA) epoxy resin further comprises a DGEBA having an Epoxy Equivalent Weight (EEW) in a range of from 1500 to 3000, preferably from 1600 to 2500, more preferably from 1700 to 2300.

Embodiment 16. The liquid epoxy adhesive composition of any one of Embodiments 1 to 15, wherein the one or more phenol novolac epoxy has an EEW in a range of from 165 to 185, preferably from 172 to 179.

Embodiment 17. The liquid epoxy adhesive composition of any one of Embodiments 1 to 16, wherein the one or more carboxyl-terminated butadiene acrylonitrile (CTBN) is adducted with DGEBF, DGEBA or both adducts are present.

Embodiment 18. The liquid epoxy adhesive composition of any one of Embodiments 1 to 17, wherein the one or more carboxyl-terminated butadiene polymers (CTB) is adducted with DGEBF, DGEBA or both adducts are present.

Embodiment 19. The liquid epoxy adhesive composition of any one of Embodiments 1 to 18, wherein the one or more carboxyl-terminated butadiene acrylonitrile (CTBN) is adducted with carboxyl-terminated butadiene homopolymer (CTB) and one or more of DGEBF, DGEBA.

Embodiment 20. The liquid epoxy adhesive composition of any one of Embodiments 1 to 19, wherein the core shell rubber (CSR) particles:
(a) are practically monomodally or bimodally dispersed;
(b) have a mean particle size of 50 nm, 75 nm, 100 nm, 125 nm, 150 nm, 175 nm, 200 nm, 250 nm, or 500 nm, or in a range bounded by any two of the foregoing values;
(c) have a core comprising, consisting essentially of, or consisting of polybutadiene, a butadiene/styrene copolymer, or an acrylic polymer or copolymer; and/or
(d) are dispersed in DGEBA epoxy resin.

Each of the various descriptions concerning these CSR particles (characterizations, compositions, and sizes) set forth elsewhere in this disclosure as seen as independent Aspects of this Embodiment.

Embodiment 21. The liquid epoxy adhesive composition of any one of Embodiments 1 to 20, wherein the at least one heat-activated latent curing agent comprising DICY; comprises one or more dicyandiamide (DICY) that is a micronized dicyandiamide (cyanoguanidine). In certain Aspects of this Embodiment, the micronized dicyandiamide is not fully dissolved in the liquid epoxy adhesive composition. In certain Aspects of this Embodiment, at least 98% of the micronized dicyandiamide has a particles size of 40 microns or less. In other Aspect, at least 98% of the micronized dicyandiamide has a particles size of 10 microns or less. In other Aspect, at least 98% of the micronized dicyandiamide has a particles size of 6 microns or less.

Embodiment 22. The liquid epoxy adhesive composition of any one of Embodiments 1 to 21, wherein the one or more flame retardant is present. In certain Aspects of this Embodiment, the flame retardant is or comprises one or more of aluminum trihydrate (ATH), an ammonium polyphosphate, melamine, melamine polyphosphate, a phosphonate ester (e.g., diethyl bis(hydroxyethyl) aminomethyl phosphonate, a halogen-free phosphorus ester, or any combination of an unsubstituted, mono-, di-, or tri-butylated phenyl phosphates. In certain Aspects of this Embodiment, the flame retardant is a liquid, and the composition is free of solid flame retardants, optionally ATH may be present as a filler.

Embodiment 23. The liquid epoxy adhesive composition of any one of Embodiments 1 to 22, wherein the one or more filler comprises one or more of calcium carbonate, calcium oxide, calcium silicate, aluminosilicate, organophilic phyllosilicates, naturally occurring clays such as bentonite, wollastonite or kaolin glass, silica, polyhedral oligomeric silsesquioxane (POSS), mica, talc, optionally functionalized graphite, optionally functionalized graphene, microspheres (polymeric or glass beads), or hollow glass microspheres, chopped or milled fibers [e.g., carbon, glass, or aramid], pigments, zeolites (natural or synthetic), or thermoplastic fillers.

Embodiment 24. The liquid epoxy adhesive composition of any one of Embodiments 1 to 23, wherein the at least one accelerator different from the curing agent may be one or more accelerators comprising urea, a guanidine that is not cyanoguanidine, or a substituted urea accelerator; preferably a substituted urea accelerator, more preferably a micronized substituted urea accelerator. In certain Aspects of this Embodiment, the substituted urea accelerator is substituted urea and/or a bridged diurea (with each urea substituted with one, two, three, or four alkyl and/or aromatic groups. In some aspects of this embodiment, the one or more accelerators preferably comprises substituted urea, optionally alkyl substituted urea comprising dimethyl urea, e.g., 1,1 dimethyl urea and/or 1.3 dimethyl urea, such as set forth elsewhere herein and incorporated here. In some Aspects of this Embodiment, the accelerator becomes activated in a temperature range of 100° C. to 120° C., from 120° C. to 140° C., from 140° C. to 160° C., or from 160° C. to 180° C., or a combination of two or more of these ranges. In certain Aspect of this Embodiment, the substituted urea accelerator becomes activated at a temperature that exceeds the deblocking temperature of the optional polyurethane, preferably at a temperature of at least about 160° C. to meet low temperature cure in E-coat ovens. In some Aspects of this Embodiment, liquid epoxy adhesive composition comprises at least two accelerators.

Embodiment 25. The liquid epoxy adhesive composition of any one of Embodiments 1 to 24, wherein the one or more polyetheramine flexibilizer is a polyalkylene glycol, comprising amine end-caps; the one or more polyetheramine flexibilizer may be present as a DGEBA adduct. The polyetheramine is preferably an end-capped polypropylene glycol characterized by repeating oxypropylene units in the backbone. The flexibilizer may have an average weight averaged molecular weight in a range of from about 1000 to 3000 Daltons, preferably 1500 to 2500 or more preferably about 2000 Daltons. Such materials are commercially available as JEFFAMINE® D-2000 polyetheramine.

Embodiment 26. The liquid epoxy adhesive composition of any one of Embodiments 1 to 25, wherein the one or more plasticizer is present and is or comprises tricresyl phosphate. In certain Aspects of this Embodiment, the plasticizer is selected from the group consisting of triphenylphosphate, tricresyl phosphate, and phenyl cresyl esters of pentadecyl sulfonic acid.

Embodiment 27. A method of making a composite article which comprises steps of: contacting a surface with the liquid epoxy adhesive composition of any one of Embodiments 1 to 26, provisionally adhering an uncured epoxy on the surface. In certain Aspects of this Embodiment, at least two surfaces are contacted with the composition, said surfaces being positioned such that the uncured epoxy is positioned therebetween. In certain Aspects of this Embodiment, a precured intermediate composite article is formed by pre-curing the provisionally adhered uncured epoxy on the surface for a time period of 10 minutes to 25 minutes at temperatures in a range of 160° C. to 185° C., preferably about 13 min at about 173° C., plus or minus 10-20%.

Embodiment 28. A cured epoxy adhesive layer that has been prepared by thermally curing a liquid epoxy adhesive composition of any one of Embodiments 1 to 27 on a substrate. In certain Aspects of this Embodiment, the cured epoxy adhesive layer has a nominal thickness in a range of from 0.25 to 0.5 mm nominal, preferably about 0.25 mm.

Embodiment 29. The cured epoxy adhesive layer of Embodiment 28 that has been cured: (a) at a temperature of 160° C. for 10 minutes; or (b) at a temperature of 205° C. for 30 minutes. Time refers to the total time the adhesive is at the indicated cure temperature. The epoxy adhesive layer may be cured at other temperatures as dictated by the paint cure over parameters, e.g., in the range of 150-210° C. 160-205° C. 165-200° C. and other temperatures within the recited ranges. Cure times of 10-30 minutes include other cure times within the recited ranges. Other temperature time combinations may be used as is known in the art. The adhesive may be cured at higher temperatures and longer cure times provided that the cure conditions do not interfere with other objects of the invention with respect to performance of the cured adhesive.

For CKD processes, the cured epoxy adhesive layer has been cured in a two-step process wherein a pre-curing takes place at temperatures in a range of at least about 140, 150, 160, 162, 164, 166, 168, 170, 172, 173 and not more than 175, 176, 177, 178, 180, 183 or 185° C. for times in a range of about 10, 11, 12, 13, 14, 15, 16, 17, or 18 minutes and preferably not more than 25, 24, 23, 22, 21, 20 or 19 minutes, more preferably in range of about 160-175° C. for time periods in a range of 10-15 minutes, the time period being reduced for higher temperature. The pre-cure step is followed after an extended time of days to weeks, by a second full curing step generally during paint curing, such as E-coat processing.

Embodiment 30. The cured epoxy adhesive layer of Embodiment 28 or 29, wherein the substrate is a cold rolled steel (CRS), an electro galvanized steel (EZG), a hot dip galvanized steel (HDG), or aluminum (optionally treated). In certain Aspects of this Embodiment, the substrate (also called an adherend) has a thickness in a range of from 0.7 mm to 2.0 mm.

Embodiment 31. The cured epoxy adhesive layer of any one of Embodiments 28 to 30 that exhibits a 100% cohesive mode of failure in peel on cold rolled steel (CRS), electro galvanized steel (EZG), hot dip galvanized steel (HDG), and/or treated aluminum when tested under T-peel conditions of ASTM D1876 08(2015)e1 or under the wedge impact method of ISO 11343.2019.

Embodiment 32. The cured epoxy adhesive layer of any one of Embodiments 28 to 31, which:
(a) having been deposited on a first 1.5 mm HDG plate, exposed to 80% relative humidity in an uncured state for 72 hrs. at 23° C., positioned between the first 1.5 mm HDG plate and a second 1.5 mm HDG plate and pressed into a sandwich, cured at 175° C. for 25 min. and tested according to (ASTM D1002) exhibits lap shear strength of at least 28, 30, 32, 34, 36, or 38 MPa; and/or shows at least 90, 95, 97 98, 99 or 100% cohesive failure mode and/or
(b) having been humidity exposed according to the CKD protocol disclosed herein and tested according to (ASTM D1002) exhibits lap shear strength of at least 20, 21, 22, 23, 24, 26, 28, 30, 32, 34, 36, or 38 MPa; and/or shows at least 90, 95, 97 98, 99 or 100% cohesive failure mode and/or
(c) having been cured between two 0.8 mm thick cold rolled steel plates at 175° C. for 25 min exhibits a cleavage resistance under impact loading [impact wedge peel strength] of at least 20, 22, 24, 26, 28, 30, 22, 24, 26, 28, 30, 32, 34, 36, 38, 40, 42, 44, 46, 48, 50 or 52 N/mm when tested using the wedge impact method of ISO 11343.2019 at −40° C.; and/or
(d) having been cured between two 0.8 mm thick cold rolled steel plates at 175° C. for 25 min exhibits a cleavage resistance under impact loading [impact wedge peel strength] of at least 20, 22, 24, 26, 28, 30, 32, 34, 36, 38, 40, 42, 44, 46, 48, 50 or 52 N/mm when tested using the wedge impact method of ISO 11343.2019 at 23° C.; and/or
(e) having been cured between two 0.8 mm thick HDG plates at 175° C. for 25 min. provides adhesion between the plates sufficient when tested according to ASTM D1876-08(2015)e1 to exhibit a T-peel strength of at least 4, 5, 6, 7, 8, 9, 10, 11, 12, 13, 14, or 15 N/mm; and/or
(f) having been cured between two 2.0 mm thick 5754 aluminum plates at 175° C. for 25 min provides adhesion between the plates sufficient when tested under T-peel conditions of ASTM D1876-08(2015)e1 to exhibit a T-peel strength of at least 5, 6, 7, 8, 9, 10, 11, 12, 13, 14, or 15 N/mm.

Specific Aspects of this Embodiment are provided in the Examples and are incorporated herein.

Embodiment 33. An article of manufacturing comprising a liquid epoxy adhesive composition of any one of Embodiments 1 to 26, as applied on at least one surface of the article and uncured. In certain Aspects of this Embodiment, the article of manufacturing is an automobile, a home appliance, or a part thereof.

Embodiment 34. An article of manufacturing comprising a liquid epoxy adhesive composition of any one of Embodiments 1 to 26, as applied on at least one surface of the article and pre-cured to at least 50%, 60%, 70% or 80% and less than 95, 96, 97, 98, 99% cure of the epoxy adhesive, as measured by differential scanning calorimetry. In certain Aspects of this Embodiment, the article of manufacturing is an automobile, a home appliance, or a part thereof.

Embodiment 35. An article of manufacturing comprising any cured epoxy adhesive layer of any one of Embodiment 28 to 32. In certain Aspects of this Embodiment, the article of manufacturing is an automobile, a home appliance, or a part thereof.

Embodiment 36. A method of preparing the liquid epoxy adhesive composition of any one of Embodiments 1 to 26, the method comprising steps, at a temperature less than the activation energy of the final desired composition, of: 1) combining liquid components, 2) mixing solid components, except curing agent and accelerator, into the combination of step 1), and 3) incorporating curing agent and accelerator into the mixture.

Embodiment 37. A method of making a bonded assembly comprising: applying the composition of any one of Embodiments 1 to 26 on a first surface, contacting at least one second surface with the composition on the first surface and curing the composition in contact with the first and second surfaces to prepare a bonded assembly. In certain Aspects of this Embodiment, one or more of the first and second surfaces is contaminated with at least one oily substance and the composition additionally comprises at least one chelate-modified epoxy resin.

Embodiment 38. An article of manufacturing comprising the liquid epoxy adhesive composition of any one of Embodiments 1 to 26, as applied on at least one surface of the article and uncured; or cured on the at least one surface of the article, wherein the article of manufacturing is preferably automobile or a part thereof.

The disclosure also embraces the use of these liquid epoxy adhesive compositions in forming a bonding surface comprising a corresponding cured epoxy adhesive layer and methods of using them for this purpose, as well as the cured epoxy adhesive layer that has been prepared by thermally curing the liquid epoxy adhesive compositions between substrates.

Recommended thicknesses of the cured adhesive layers are provided as are the conditions for curing the adhesive compositions. Exemplary curing conditions include curing at a temperature of in a range of 160° C. to 205° C. for time periods in a range of about 10 minutes to about 30 minutes. In some embodiments a pre-cure in a range of about 160° C. to about 185° C. for time periods of about 10 minutes to about 25 minutes; or at a temperature of for 30 minutes. Typical substrates include, but are not limited to, cold rolled steel (CRS), an electro galvanized steel (EZG), a hot dip galvanized steel (HDG), or a treated aluminum.

Upon curing, the adhesives provide excellent adhesion between such surfaces. In some embodiments, the cured adhesive layer exhibits a 100% cohesive mode of failure in peel on cold rolled steel (CRS), electro galvanized steel (EZG), hot dip galvanized steel (HDG), and/or treated aluminum when tested under T-peel conditions of ASTM-D1876.

The disclosure also embraces article of manufacturing comprising any one or more of the cured epoxy adhesive layer set forth herein.
Several of the many advantages of the compositions presently disclosed include:
(1) Excellent adhesion properties and impact wedge peel strength on steel and aluminum substrates, especially at −40° C. (where traditional toughened epoxy polymers tend to exhibit brittle failure under high strain rate impact events)—while maintaining excellent uncured, open bead humidity resistance;
(2) The use of a synergistic combination of epoxy resin, CTB and CTBN tougheners, curing and accelerating agents as well as fillers and thixotropic agents provides improved adhesion to steel and aluminum and humidity resistance relative to currently commercial materials; (3) Enhanced CKD performance of pre-cure, aging and final cure, particularly when exposed to humidity in the uncured and/or during aging.

### BRIEF DESCRIPTION OF THE DRA WINGS

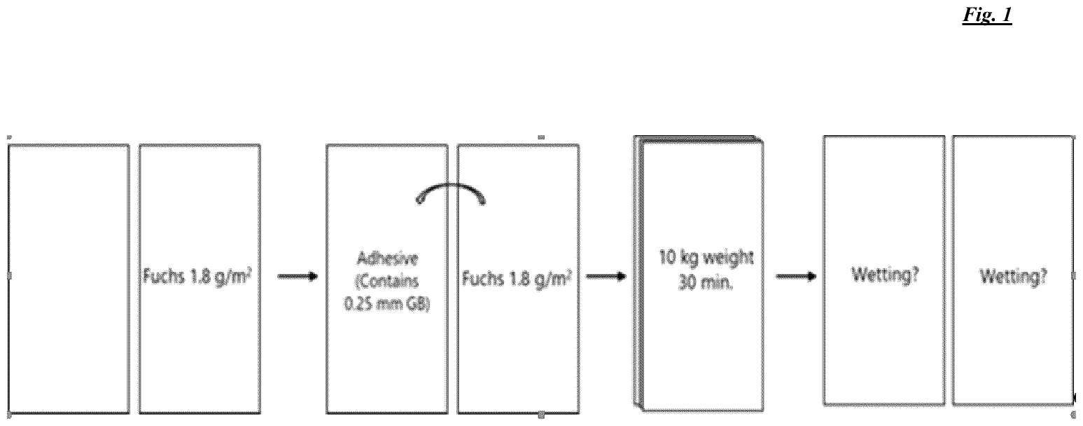

FIG. 1 illustrates a panel separation test used in the Examples.

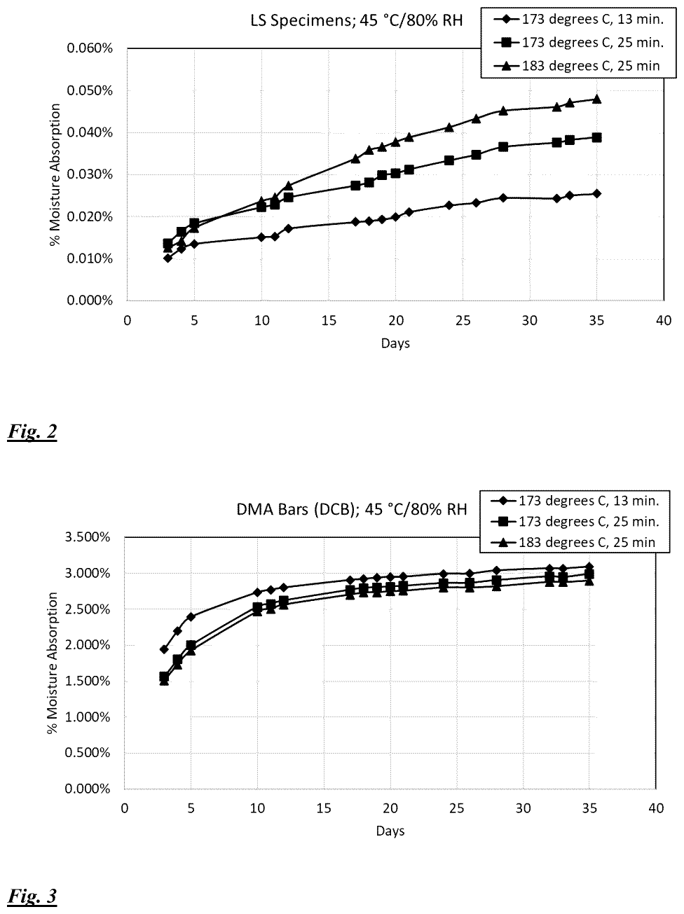

FIG. 2 shows a graphic illustration of moisture absorption by adhesive in lap shear specimens exposed to 45° C. and 80% relative humidity as a function of duration of CKD exposure prior to secondary cure.

FIG. 3 shows a graphic illustration of moisture absorption by adhesive bulk dynamic mechanical analysis (DMA) specimens exposed to 45° C. and 80% relative humidity as a function of duration of CKD exposure prior to secondary cure.

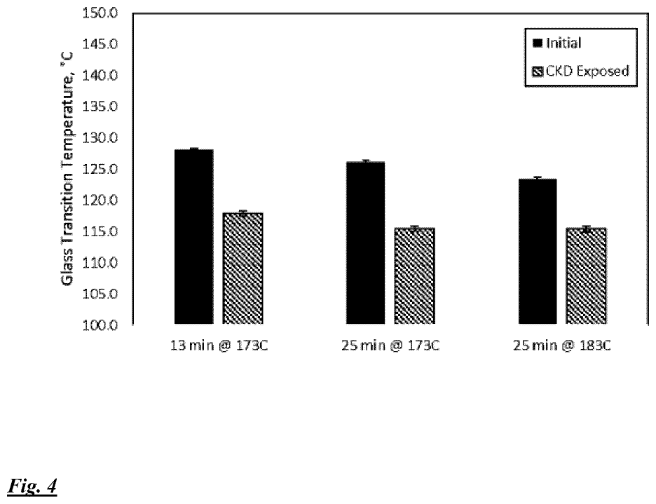

FIG. 4 shows a histogram illustration comparing DMA glass transition temperature (Tg) of specimens before and after CKD testing.

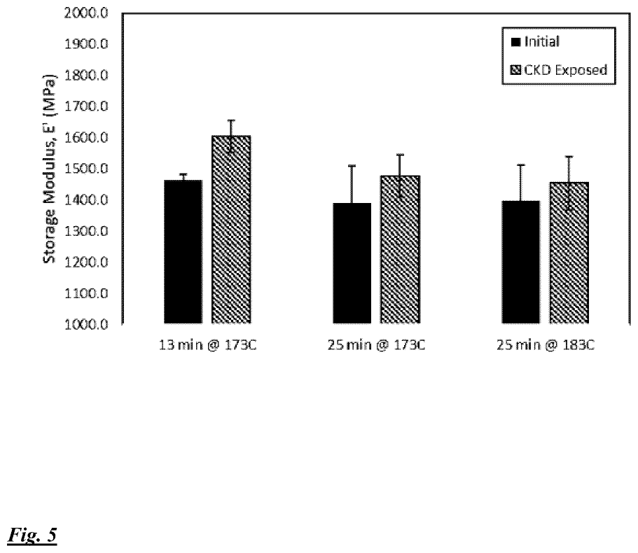

FIG. 5 shows a histogram illustration comparing DMA storage modulus (E′) of specimens before and after CKD testing.

### DETAILED DESCRIPTION OF ILLUSTRATIVE EMBODIMENTS

The present disclosure may be understood more readily by reference to the following description taken in connection with the accompanying Summary, Figures and Examples, all of which form a part of this disclosure. Those Components identified by their commercial tradenames are independent embodiments of the materials to which they are referred. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

### The Liquid Epoxy Adhesive Compositions

Certain embodiments set forth in this disclosure include liquid epoxy adhesive compositions comprising:
(a) at least one epoxy resin;
(b) one or more carboxyl-terminated butadiene rubbers;
(c) rubber particles, preferably core-shell rubber (CSR) particles and/or particles having a particle size of less than 500 nm, most preferably nanoscale core-shell rubber particles, meaning at least one dimension of a particle is less than 100 nm. The distribution of particle sizes may vary, with particular embodiments described herein;
(d) optionally, one or more blocked polyurethane toughening agents wherein the one or more blocked polyurethane toughening agents comprises at least one asymmetrically end-capped polyurethane;
(e) at least one heat-activated latent curing agent comprising DICY;
(f) at least one accelerator different from the curing agent;
wherein (b) comprises at least one carboxyl-terminated butadiene homopolymer (CTB) and at least one carboxyl-terminated butadiene acrylonitrile copolymer (CTBN).

In certain embodiments, the liquid epoxy adhesive compositions comprise:
(a) one or more diglycidyl ether of a bisphenol-A (DGEBA) epoxy resins or bisphenol-F (DGEBF) epoxy resins, desirably present in a range of from 20 wt. % to 80 wt. %;
(b) at least two selected from a carboxyl-terminated butadiene homopolymer (CTB)-epoxy adducts, a carboxyl-terminated butadiene acrylonitrile copolymer (CTBN)-epoxy adduct, or an adduct of carboxyl-terminated butadiene homopolymer (CTB) and carboxyl-terminated butadiene acrylonitrile copolymer (CTBN) and epoxy, desirably each independently present in a range of from 1 wt. % to 30 wt. %;
(c) core shell rubber (CSR) particles, desirably present in a range of from 5 wt. % to 40 wt. %;
(d) optionally one or more blocked polyurethane toughening agents, desirably present in a range of from 0 wt. % to 20 wt. %;
(e) one or more dicyandiamides (DICY), desirably present in a range of from 2 wt. % to 7 wt. %;
(f) one or more urea-based accelerator, desirably present in a range of from 0.3 wt. % to 2.0 wt. %;
(g) one or more filler, desirably present in a range of from 0 wt. % to 35 wt. %;
(h) one or more phenol novolac epoxies, desirably present in a range of from 1 wt. % to 20 wt. %;
(i) one or more flame retardants, desirably present in a range of from 0 wt. % to 35 wt. %;
(j) one or more polyetheramine flexibilizer, desirably present in a range of from 3 wt. % to 30 wt. %; and
(k) one or more thixotropic agents, desirably present in a range of from 0 wt. % to 25 wt. %;
wherein the wt. % of each component is relative to the total weight of the composition and the total amount of the components does not exceed 100 wt. %.

Each of these ranges are considered independently and exemplary independent ranges and subranges for each of these components are set forth elsewhere herein.

### Epoxy Resins

In general, a large number of polyepoxides having at least about two 1,2-epoxy groups per molecule are suitable as epoxy resins for the compositions of this invention. The poly epoxides may be saturated, unsaturated, cyclic or acyclic, aliphatic, alicyclic, aromatic or heterocyclic polyepoxide compounds. Examples of Suitable polyepoxides include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A (bis(4-hydroxyphenyl)-2,2-propane), bisphenol F (bis(4-hydroxyphenyl) methane), bis(4-hydroxyphenyl)-1,1-isobutane, 4,4′-dihydroxybenzophenone, and bis(4-hydroxyphenyl)-1, 1-ethane. Other suitable polyphenols as the basis for the polyglycidyl ethers are the known condensation products of phenol and formaldehyde or acetaldehyde of the novolac resin-type. Particular preference is given to the liquid epoxy resins derived by reaction of bisphenol A or bisphenol F and epichlorohydrin. The epoxy resins that are liquid at room temperature generally have epoxy equivalent weights of from 150 to about 480. In preferred embodiments of the liquid epoxy adhesive compositions, one or more of diglycidyl ether of the bisphenol-A (DGEBA) epoxy resins or bisphenol-F (DGEBF) epoxy resins may be present individually or together. In certain embodiments, one or both of these resins has an Epoxy Equivalent Weight (EEW) in a range of from 155 to 400, 160 to 300, 165 to 200, 170 to 250, or 180 to 200, preferably from 185 to 195, where

$$EEW = \frac{MW epoxy resin}{Number ( \# ) of epoxy groups} .$$

Suitable commercially available polyphenol polyglycidyl ether products include diglycidyl ethers of bisphenol A resins such as are sold by Olin Corporation under the tradename D.E.R.®, including the 300 and 600 series resins. Other aliphatic epoxy diluents/flexibilizers, from the D.E.R.® 700 series, may also be incorporated to decrease viscosity (i.e., as a diluent), to increase flexibility/elongation and improve adhesion.

### Carboxyl-Terminated Butadiene Rubbers (CTBN) and (CTB)

Additionally or alternatively, in the adhesive composition, the one or more carboxyl-terminated butadiene acrylonitriles (CTBN) comprises a copolymer of butadiene and a nitrile monomer, preferably acrylonitrile or may comprise a homopolymer of butadiene. Acrylonitrile content may range from about 10-30 wt. % based on weight of the CTBN, and in some preferred embodiments, the CTBN compositions contain about 26 wt. % acrylonitrile. It appears that the increased solubility retards onset (kinetics) of phase separation during cure, resulting in a smaller particle size and increased fracture toughness.

These carboxyl-terminated butadiene acrylonitriles (CTBN) may contain from about 1.5, more preferably from about 1.8, to about 2.5, more preferably to about 2.2, terminal epoxide-reactive carboxyl groups per molecule, on average. The molecular weight (Mn) of the carboxyl-terminated butadiene acrylonitriles may be suitably from about 2000 to about 6000, more preferably from about 3000 to about 5000. Acid number of the carboxyl-terminated butadiene acrylonitriles may be in a range of 25 to 40. In certain preferred embodiments, a portion of the one or more carboxyl-terminated butadiene acrylonitrile (CTBN) may be adducted with DGEBA or DGEBF. The adduct may be dissolved or dispersed in novolac epoxy resin which aids solubility. In preferred embodiments, the CTBN may be a CTBN-DGEBF adduct in novolac epoxy resin or may be CTBN-DGEBA.

Additionally or alternatively, in the adhesive composition, the one or more carboxyl-terminated butadiene homopolymers (CTB) may be present and contribute to cured adhesive performance when the uncured or pre-cured adhesive has been exposed to humidity exposure. These carboxyl-terminated butadiene copolymers (CTB) may contain from about 1.5, more preferably from about 1.7, to about 2.5, more preferably to about 2.1, terminal epoxide-reactive carboxyl groups per molecule, on average. The molecular weight (Mn) of the carboxyl-terminated butadiene polymer may be suitably from about 2000 to about 6500, more preferably from about 3000 to about 5500. Acid number of the carboxyl-terminated butadiene polymer may be in a range of about 20-30. In certain preferred embodiments, a portion of the one or more carboxyl-terminated butadiene copolymers (CTB) may be adducted with DGEBA or DGEBF. In a particularly preferred embodiment, some or all of the one or more carboxyl-terminated butadiene copolymers (CTB) may be present in an epoxy adduct of carboxyl-terminated butadiene acrylonitrile (CTBN) and carboxyl-terminated butadiene copolymer (CTB).

Suitable carboxyl-functional butadiene and butadiene/acrylonitrile copolymers are commercially available from Huntsman under the tradenames Hycar® and Hypro®, and suitable carboxyl-terminated butadiene rubbers adducted with DGEBA or DGEBF are commercially available from Huntsman under tradename Hypox™.

### Core Shell Rubber (CSR) Particles

Core shell rubber (CSR) particles generally have a core comprised of a polymeric material having elastomeric or rubbery properties (i.e., a glass transition temperature less than about 0° C. e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.), as measured by differential scanning calorimetry (DSC). The rubber core may constitute from 50 to 90%, especially from 50 to 85% of the weight of the core-shell rubber particle.

In some embodiments, the CSR particles have an average particle size less than about 500 nm. In still other embodiments, the CSR particles have an average particle size greater than about 500 nm, for example average particle size may be from about 0.03 to about 2 microns or from about 0.05 to about 1 micron. Desirably, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm. The core-shell rubber particles may have a number average particle size (diameter) of 10 to 300 nanometers, especially 75 to 250 nanometers, as determined by transmission electron spectroscopy.

The core may be comprised of a diene homopolymer or copolymer of monomers comprising one or more of butadiene, isoprene, ethylenically unsaturated monomers such as vinyl aromatic monomers, (meth)acrylonitrile, (meth)acrylates, or the like, polybutadiene cored particles are preferred. Other suitable rubbery core polymers may include polybutylacrylate or polysiloxane elastomer (e.g., polydimethylsiloxane).

The shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature; acrylates, in particular, poly(methylmethacrylates) are preferred. The shell polymer or copolymer may be crosslinked and/or have one or more different types of functional groups (e.g., carboxylic acid or epoxy groups) that are capable of interacting with other components of the adhesive. In one embodiment, the shell polymer may be polymerized from at least one lower alkyl methacrylate such as methyl-, ethyl- or t-butyl methacrylate. Up to 40% by weight of the shell polymer can be formed from other monovinylidene monomers such as styrene, vinyl acetate, and vinyl chloride, methyl acrylate, ethyl acrylate, butyl acrylate, and the like. The shell polymer may be a homopolymer of any of such lower alkyl methacrylate monomers. The molecular weight (Mn) of the grafted shell polymer is generally between 20,000 and 500,000. The rubber particle may be comprised of more than two layers (e.g., a central core rubbery material may be surrounded by a different rubbery material then shell or two shells or hard shell, soft shell, hard shell). The shell may be grafted onto the core.

CSR particles may be prepared as a masterbatch where the rubber particles are dispersed in one or more epoxy resins such as a diglycidyl ether of bisphenol A, preferably remaining as separated individual particles with little or no agglomeration of the particles or precipitation (settling) of the particles as the masterbatch is aged by standing at room temperature. The core-shell rubber particles may be provided as a dispersion in an epoxy or a phenolic resin matrix. Such a dispersion may contain, for example, about 5 to about 50% by weight (about 15 to about 40% by weight) of the core-shell rubbers, with the remainder being the epoxy resin. The epoxy resin in such a dispersion is preferably a polyglycidyl polyphenol ether as described above. The matrix material preferably is liquid at room temperature. Examples of epoxy matrices include the diglycidyl ethers of bisphenol A, For S, or bisphenol, novolac epoxies, and cycloaliphatic epoxies. Examples of phenolic resins include bisphenol-A based phenoxies. Commercially available as dispersions of rubber particles having a core-shell structure in an epoxy resin matrix are those available from Kaneka Corporation under the tradename “ACE MX” described as having a polybutadiene core or a copolymer core of (meth)acrylate-butadiene-styrene, where butadiene is the primary component in phase separated particles, dispersed in epoxy resins. When the core-shell rubber particles are provided in the form of such a dispersion, only the weight of the core-shell rubber particles is counted toward the core-shell rubber component of this disclosure. Methods of making masterbatches are described EP 1632533, U.S. Pat. Nos. 4,778,851 and 6,111,015, each incorporated herein by reference in its entirety.

Examples of CSR particles suitable for use in the present compositions include those commercially available from: Rohm & Haas under the tradename PARALOID EXL 2600/3600 series, described as styrene/methylmethacrylate copolymer grafted onto a polybutadiene core, average particle size of 0.1-0.3 microns; Rochm GmbH or Rochm America, Inc. under the tradename DEGALAN; Nippon Zeon under the tradename F351; and in powder form from Wacker Chemie under the tradename GENIOPERL, described by the supplier as having crosslinked polysiloxane cores, epoxy-functionalized polymethylmethacrylate shells, polysiloxane content of about 65 weight percent.

Combinations of different core-shell rubber particles may advantageously be used in the present invention. The core-shell rubber particles may differ, for example, in particle size, the glass transition temperatures of their respective cores and/or shells, the compositions of the polymers used in their respective cores and/or shells, the functionalization of their respective shells, and so forth. A portion of the core-shell particles may be supplied to the adhesive composition in the form of a masterbatch wherein the particles are stably dispersed in an epoxy resin matrix and another portion may be supplied to the adhesive composition in the form of a dry powder (i.e., without any epoxy resin or other matrix material). For example, the adhesive composition may be prepared using both a first type of core-shell particles in dry powder form having an average particle diameter of from about 0.1 to about 0.5 microns and a second type of core-shell particles stably dispersed in a matrix of liquid bisphenol A diglycidyl ether at a concentration of from about 5 to about 50 weight % having an average particle diameter of from about 25 to about 200 nm. The weight ratio of first type:second type core-shell rubber particles may be from about 1.5:1 to about 0.3:1, for example.

Alternatively or with the CSR, the compositions may comprise rubber particles that do not have shells that encapsulate a central core. In such embodiments, the chemical composition of the rubber particles may be essentially uniform throughout each particle or may have its outer surface modified by irradiation or chemical processing to aid in dispersion in the matrix or adhesion thereto. The polymers suitable for use in preparing rubber particles that do not have shells may be selected from any of the types of polymers previously described as suitable for use as the core of core-shell rubber particles. The polymer may contain functional groups such as carboxylate groups, hydroxyl groups or the like and may have a linear, branched, crosslinked, random copolymer or block copolymer structure. Exemplary commercially available rubber particles include acrylonitrile/butadiene copolymer, butadiene/styrene/2-vinylpyridine copolymer; hydroxy-terminated polydimethylsiloxane; and similar elastomeric solid rubbers. These particles may optionally be surface modified to create polar groups (carboxylic acid or hydroxyl groups) and/or doped with minor amounts of inorganic materials such as calcium carbonate or silica, as is known in the art. When the rubber particles do not have a core-shell structure, desirably the rubber particles have an average diameter of less than about 750 nm, 500 nm, or 200 nm. For example, the rubber particles may have an average diameter ranging from about 25 to about 200 nm or from about 50 to about 150 nm.

In the adhesive composition, in some preferred embodiments, the core shell rubber (CSR) particles may be characterized by one or more of the following features: (a) the CSR particles are monomodally or bimodally dispersed, allowing for maximum concentrations; the dispersity of the CSR particles may be defined by any suitable means including sedimentation or visual or automated of transmission electron microscopy (TEM) images; (b) the CSR particles have a mean particle size of 50 nm, 75 nm, 100 nm, 125 nm, 150 nm, 175 nm, 200 nm, 250 nm, or 500 nm, or in a range bounded by any two of the foregoing values; in still another embodiment, the rubber particles have a core-shell structure and an average particle size greater than about 500 nm; (c) the CSR particles have a core comprising, consisting essentially of, or consisting of polybutadiene, a butadiene/styrene copolymer, or an acrylic polymer or copolymer; and/or (d) the CSR particles are dispersed in DGEBA epoxy resin.

In the disclosed compositions, use of these core shell rubbers allows for toughening to occur in the formulation, irrespective of the temperature or temperatures used to cure the formulation. That is, because of the two-phase separation inherent in the formulation due to the core shell rubber—as contrasted for instance with a liquid rubber that is miscible or partially miscible or even immiscible in the formulation and can solidify at temperatures different than those used to cure the formulation—there is a minimum disruption of the matrix properties, as the phase separation in the formulation is often observed to be substantially uniform in nature. In addition, predictable toughening—in terms of temperature neutrality toward cure—may be achieved because of the substantial uniform dispersion.

### Blocked Polyurethane Toughening Agents

Additionally or alternatively, in the adhesive composition, optionally one or more blocked polyurethane toughening agents may be present, optionally comprising a polyalkylene glycol segment. In some embodiments, the blocked polyurethane toughening agent provides improved adhesion to the contemplated substrates under static and dynamic peel conditions.

In embodiments where the optional polyurethane is present, the polyalkylene glycol segment independently comprises a polyethylene glycol, a polypropylene glycol, or a polybutylene glycol (alternatively a polytetramethylene glycol (poly-THF or PTMEG), having an equivalent molecular weight in a range of from 2000-5000 Daltons. PTMEG linkages are preferred. In other further preferred embodiments, the polyurethane toughening agent also contains polyalkylene (extender) segments, preferably where the polyalkylene glycol segment is flanked by end-capped C1-10 alkylene linkages, preferably C6-8 alkylene linkages and coupled thereto by urethane groups.

Other elastomeric “tougheners” having capped isocyanate groups that may also be suitable in the presently disclosed composition, have been described, for example, in any of U.S. Pat. Nos. 5,202,390, 5,278,257, WO 2005/118734, WO 2007/003650, WO2012/091842, U. S. Published Patent Application No. 2005/0070634, U. S. Published Patent Application No. 2005/0209401. U.S. Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285. These elastomeric tougheners (2) can be generally described as the products of the reaction of an amine- or hydroxyl-terminated rubber with a polyisocyanate to form an isocyanate-terminated prepolymer, optionally chain-extending the prepolymer, followed by capping the isocyanate groups with a capping group such as, for example: a) aliphatic, aromatic, cycloaliphatic, araliphatic and/or heteroaromatic monoamines that have one primary or secondary amino group; b) phenolic compounds, including monophenols, polyphenols and aminophenols: c) benzyl alcohol, which may be substituted with one or more alkyl groups on the aromatic ring; d) hydroxy-functional acrylate or methacrylate compounds: e) thiol compounds such as alkylthiols having 6 to 16, carbon atoms in the alkyl group, including dodecanethiol; f) alkyl amide compounds having at least one amine hydrogen such as acetamide and N-alkylacetamide; and g) a ketoxime.

In the embodiments where the optional polyurethane is present, the, the one or more blocked polyurethane toughening agent is preferably end-capped at both ends of the structure. The two end-capping groups of the blocked polyurethane toughening agent may be the same or different. Selecting combinations of differing end-caps allows one to tune the deblocking temperatures. In some embodiments, then, the end caps are chosen to provide de-blocking temperatures in a range of from 135° C. to 140° C., from 140° C. to 145° C., from 145° C. to 150° C., from 150° C. to 160° C., from 160° C. to 165° C., or a range defined by any two or more of the foregoing ranges, for example from 140° C. to 150° C.

Huntsman's DY 965 is one commercially available example of such a blocked polyurethane toughening agent, in which both end-caps comprise bisphenol. While in some cases, end-capping by one or more bisphenol (e.g., bis-phenol A) groups may be acceptable, the present inventors have found that the use of one or more blocking groups that provide lower deblocking temperatures are preferred. Such end-capping agents include optionally substituted phenols (or hydroxyheteroaryl analogs), amines, methacryl, acetoxy, oximes, and/or pyrazoles (see Johannes Karl Fink, in High Performance Polymers (Second Edition), 2014; https://www.sciencedirect.com/topics/engineering/blocked-isocyanate). It is known, for example, that the aliphatic poly(isocyanate) s, which are blocked with equimolar quantities of diisopropylamine and malonic acid diethyl ester, have a crosslinking temperature of 130° C. Triazole blocked isocyanates are typically stable up to 130-140° C.

In some embodiments, where the optional polyurethane is present, the blocked polyurethane toughening agent has at least one end cap derived from methylethylketone oxime, 2,4-dimethyl-3-pentanone oxime or 2,6-dimethyl-4-heptanone oxime, diethyl malonate, 3,5-dimethylpyrazole. 1,2,4-triazole, or mixtures of diisopropylamine and 1,2,4-triazole, or combinations thereof.

End-cap substituents that are hydrophobic also appear to ensure additional benefits, including for example C12-24 pendant functional groups comprising 1, 2, 3, or 4 conjugated and/or non-conjugated alkenylene bonds. Accordingly, in separate embodiments, the optional substituents of the phenols (or hydroxyheteroaryl analogs), amines, methacryl, acetoxy, oximes, and/or pyrazoles comprise such pendant functional groups.

In other embodiments, where the optional polyurethane is present, the flanking C1-10 alkylene linkages is end-capped by at least one monophenol comprising at least one C12-24 pendant functional groups, the at least one C12-24 pendant functional groups containing 1, 2, 3, or 4 conjugated and/or non-conjugated alkenylene bonds. Again, the use of substituted monophenols, relative to bis-phenol is preferred in that they appear to provide a lower curing temperature than the bisphenol end-caps.

### Heat-Activated Latent Curing Agent

Compositions of the present invention are preferably one-part or single-component compositions cured at elevated temperature, containing one or more curing agents capable of accomplishing cross linking or curing of certain of the adhesive components when the adhesive is heated to an activation temperature of the curing agent and/or blocked reactants. To ensure good storage stability of the single-component, liquid epoxy adhesives, desirably, the latent curing agent has low solubility in the epoxy resins at room temperature. Solid, finely ground curing agents are preferred to permit ready dissolution at about the activation temperature, dicyandiamide (DICY) being especially suitable. In certain embodiments, the one or more dicyandiamides (DICY) of the liquid epoxy adhesive compositions is/are a micronized dicyandiamide (cyanoguanidine). The use of micronized dicyandiamide is preferred to ensure reactivity with epoxy during and after melting of the DICY, since DICY is insoluble in epoxy resins prior to melting. In certain embodiments, at least 98% of the micronized dicyandiamide has a particle size of 40 microns or less. In other embodiments, at least 98% of the micronized dicyandiamide has a particles size of 10 microns or less. In other embodiments, at least 98% of the micronized dicyandiamide has a particles size of 6 microns or less. Such materials are commercially available from AlzChem, under the tradename Dyhard®.

One or More Accelerators Different from the Latent Curing Agent

The liquid epoxy adhesive compositions comprise one or more accelerators. In certain embodiments, the one or more accelerators is or comprises urea, a guanidine, or a substituted urea Substituted urea accelerators are preferred. In other embodiments, the one or more accelerator is micronized, preferably a micronized substituted urea. In certain embodiments, the substituted urea is urea or a bridged diurea substituted with one, two, three, or four alkyl groups. In some embodiments, the urea-based accelerator is an optionally aryl-substituted 1,1-dialkyl-3-aryl urea. It is preferred, but not necessary, that the (substituted urea) accelerator becomes activated at a temperature that exceeds the deblocking temperature of the urethanes. In some embodiments, the accelerator becomes activated in a temperature range of 100° C. to 120° C., from 120° C. to 140° C., from 140° C. to 160° C., or from 160° C. to 180° C., or a combination of two or more of these ranges. Dyhard® UR series and Omicure® U series are commercially available from AlzChem and Huntsman, respectively. The former reportedly activated in a temperature range of from 120° C. to 140° C. and the literature characterizes UR700 as a substituted urea. Omicure® U-52M is commercially available from Huntsman reportedly having a structure of 4,4′ Methylene Bis-(Phenyl Dimethyl Urea) Both of these materials are useful in these liquid epoxy adhesive compositions, and the use of either (or both) in these compositions constitute individual embodiments of the present disclosure.

In some embodiments, liquid epoxy adhesive composition comprises at least two accelerators, each becoming activated at different temperatures. If two accelerators are present, it is preferred that the first of these is one that becomes activated (has an activation temperature) when heated to a temperature within the range of 60 to 120° C., and the second becomes when heated to a temperature of at least 140° C.

### Fillers

The liquid epoxy adhesive compositions contain solid fillers that are organic or inorganic materials and provide structural integrity to the compositions prior to curing. Such fillers are known to those skilled in the art. In certain embodiments, the one or more filler comprises one or more of calcium carbonate, calcium oxide, calcium silicate, aluminosilicate, organophilic phyllosilicates, naturally occurring clays such as bentonite, wollastonite or kaolin glass, silica, polyhedral oligomeric silsesquioxane (POSS), mica, talc, optionally functionalized graphite, optionally functionalized graphene, microspheres (polymeric or glass beads), or hollow glass microspheres, chopped or milled fibers [e.g., carbon, glass, or aramid], pigments, zeolites (natural or synthetic), or thermoplastic fillers. Calcium silicate and calcium oxide are preferred. Those fillers having low aspect ratios (e.g., less than about 1) and/or very high aspect ratios (e.g., chopped or milled fibers) are also preferred.

### Phenol Novolac Epoxies

Additionally or alternatively, in the adhesive composition, one or more phenol novolac epoxies are preferably included. These multifunctional epoxy resins are typically manufactured from phenol novolac resin and epichlorohydrin. When cured, they form cured materials that possess a mesh structure with a high cross-linking density. They also demonstrate excellent performance in heat and chemical resistance. In the liquid epoxy adhesive compositions described herein, the phenol novolac epoxies desirably have an EEW in a range of from 165 to 185, preferably from 172 to 179. Suitable epoxy novolac resins include those sold under the tradename D.E.N.®, including the 300 and 400 series epoxies, commercially available from Olin Corporation.

### Flame Retardants

The liquid epoxy adhesive composition may optionally contain one or more flame retardant. The one or more flame retardant may comprise a solid, a liquid or a combination thereof. In certain embodiments, the flame retardant is or comprises one or more of aluminum trihydrate (ATH) (which may also be categorized as a filler, though when present is categorized as a flame retardant for counting purposes), ammonium polyphosphates, melamine, melamine polyphosphate, a phosphonate ester (e.g., diethyl bis(hydroxyethyl) aminomethyl phosphonate (commercially available as Fyrol® 6 phosphonate ester), a halogen-free phosphorus ester (commercially available as Fyrol® HF-9), or any combination of a unsubstituted, mono-, di-, or tri-butylated phenyl phosphates (for example, Emerald Innovation NH1 is a low viscosity liquid flame retardant engineered for use in flexible polyurethane foams, said to comprise a mixture of di-butylated phenyl phosphate(s) and triphenyl phosphate and is commercially available).

In the present compositions, liquid fire retardants appear to be preferred, especially those having higher thermal stabilities. Additionally, or alternatively, mixtures comprising unsubstituted, mono-, di-, and/or tri-butylated phenyl phosphates are preferred.

Further, this disclosure includes examples of compositions consistent with these descriptions, with flammability resistance in the uncured state to resist ignition and flame propagation during welding through the uncured adhesive.

### Polyetheramine Flexibilizer

The liquid epoxy adhesive compositions may also optionally comprise one or more flexibilizers. The inclusion of these flexibilizers is believed to contribute to the improvements seen in compositions described herein, in particular adhesion to steel and aluminum and impact wedge peel strength after automotive E-coat ‘overbake’ or ‘high bake’ cure conditions and after uncured, open bead humidity exposure. In one embodiment, the one or more flexibilizers may comprise polyetheramine flexibilizers having a polyalkylene glycol backbone, further comprising amine end-caps, for example, diamines and triamines attached to a polyether backbone typically based on ethylene oxide (EO), propylene oxide (PO) or a mix of such compounds. In some embodiments, the one or more polyetheramine flexibilizer are present as a DGEBA adduct. The polyetheramine is preferably an end-capped polypropylene glycol characterized by repeating oxypropylene units in the backbone in sufficient number to provide an average weight averaged molecular weight in a range of from about 1000 to 3000 Daltons, more preferably about 2000 Daltons. Such materials are commercially available from Huntsman as JEFFAMINE® polyetheramines.

### Other Components

These liquid epoxy adhesive compositions may also optionally comprise additional components, for example additives such as adhesion promoters; plasticizers such as tricresyl phosphate and the like; diluents, e.g., epoxy compatible chemically inert hydrocarbon resin; extenders; colorant, e.g. pigments and dyes; organic and/or inorganic, optionally surface modified, thixotropic agents, e.g. surface treated fumed silica, mixed mineral thixotropes, cellulose, guar gum, waxes etc., preferably one or more of the thixotropic agents may be hydrophobic; coupling agents, e.g., silane coupling agents, such as a gamma-glycidoxypropyltrimethoxysilane coupling agent; expanding agents, such as (HGM), blowing agents, endothermic and/or exothermic, and hollow glass microspheres; flow control agents, and antioxidants. In certain embodiments, the liquid epoxy adhesive composition is free of formaldehyde.

Preferred adhesion promoters may be selected from materials increasing adhesion to metal substrates for example chelate-modified epoxy resin, a reaction product of epoxy resin and a compound containing a chelate functional group (chelate ligand). The chelate functional group is a functional group of a compound having multiple coordinations capable of chelating with metal ions in a molecule, and includes an acid group containing phosphorus (for example, —PO(OH)₂), a carboxyl group (—CO₂H), an acid group containing sulfur (for example, —SO₃H), an amino group and a hydroxyl group (particularly, hydroxyl groups neighboring each other in an aromatic ring) and the like. The chelate ligand may include ethylenediamine, bipyridine, ethylenediamine tetraacetic acid, phenanthroline, porphyrin, crown ether and the like. Examples of suitable commercially available chelate-modified epoxy resin include EP-49-10N available from Adeka Corporation and the like.

### Methods of Making the Liquid Epoxy Adhesive Compositions

Methods of making the liquid epoxy adhesive composition are set forth herein. In certain of these embodiments, the methods comprise combining the corresponding components at a temperature less than the activation energy of the final desired composition. In certain embodiments, this temperature is in a range of from about 20° C. to about 40° C., from about 40° C. to about 60° C., from about 60° C. to about 80° C. or any combination of two or more of the foregoing ranges.

It is generally most convenient to pre-mix those components that exist as liquids at ambient temperatures before adding those components that exists as solids at ambient temperature, but the order of mixing is not believed to be critical. One exemplary method is set forth in the Examples.

### Methods of Using the Liquid Epoxy Adhesive Compositions

One particularly preferred application for the adhesives according to the present invention is in methods of forming structural bonds in vehicle construction such as at metal-to-metal interfaces such as in hem flanges and in body panel joining, for example using weld bonding, a process that combines spot welding and adhesive bonding. The use of the liquid epoxy adhesive compositions in forming a bonding surface comprising a corresponding cured epoxy adhesive layer is considered independent embodiments of the present disclosure, as are the methods of using them for this purpose.

The liquid epoxy adhesive compositions can be applied to substrates by any convenient technique. Desirably the compositions are pumpable and can be applied cold or be applied warm if desired, preferably heating only up to a temperature at which the latent curing agent is not yet activated. It can be applied manually and/or robotically, using, for example, jet spraying methods or extrusion apparatus. The compositions can be applied by extrusion from a robot in bead form or by mechanical or manual application means and can also be applied using a swirl or streaming technique. The swirl and streaming techniques utilize equipment well known in the art such as pumps, control systems, dosing guns, remote dosing devices and application guns. The adhesive may be applied to one or both of the substrates to be joined. Once the liquid epoxy adhesive composition is applied, the substrates are contacted such that the adhesive is located at a bond line between the substrates. The substrates are contacted such that the adhesive is located between the substrates to be bonded together. Thereafter, the adhesive composition is subjected to heating to a temperature at which the heat curable or latent curing agent initiates cure of the epoxy resin composition forming a bonded assembly comprising the cured epoxy adhesive located between the substrates and adhered thereto.

In some embodiments, the adhesive is formulated to function as a hot melt; that is, an adhesive which is solid at room temperature, but capable of being converted to a pumpable or flowable material when heated to a temperature above room temperature. In another embodiment, the composition of this invention is formulated to be capable of being flowed or pumped to the work site at ambient temperatures or slightly above since, in most applications, it is preferable to ensure that the adhesive is heated only up to a temperature at which the latent curing agent is not yet activated. The melted composition may be applied directly to the substrate surface or may be allowed to flow into a space separately the substrates to be joined, such as in a hem flanging operation. In yet another embodiment, the composition is formulated (by inclusion of a finely divided thermoplastic or by use of multiple curatives having different activation temperatures, for example) such that the curing process proceeds in two or more stages (partial curing at a first temperature, complete curing at a second, higher temperature). The two parts are joined together, preferably immediately after deposition of the adhesive mass, thereby provisionally bonding the two parts to each other.

The resultant bond preferably already has sufficient strength so that the still uncured adhesive is not readily washed out, as might otherwise occur, for example, if the metal sheets which are provisionally bonded to each other are treated for de-greasing purposes in a wash bath and then in a phosphating bath.

The composition is preferably finally cured in an oven at a temperature which lies clearly above the temperature at which the composition was applied to the parts to be bonded and at or above the temperature at which the curing agent and/or accelerator and/or latent expanding agent (if present) are activated (i.e., in the case of the hardener, the minimum temperature at which the curing agent becomes reactive towards the other components of the adhesive; in the case of the expanding agent, the minimum temperature at which the expanding agent causes foaming or expansion of the adhesive). Curing is performed by heating the epoxy adhesive to a temperature of 140° C. or above. Preferably, the temperature is about 220° C. or less, and more preferably about 180° C. or less. The time needed to achieve full cure depends somewhat on temperature, but in general is at least 5 minutes, and more typically is 15 minutes to 120 minutes. Curing preferably takes place at a temperature above 150° C., for example at 160 to 220° C., for about 10 to about 120 minutes.

The epoxy adhesive can be used to bond a variety of substrates together including wood, metal, coated metal, aluminum, a variety of plastic and filled plastic substrates, fiberglass, and the like. The substrates to be joined using the adhesive may be the same as or different from each other. It is preferably used for the bonding of metal parts and particularly for the bonding of steel sheets such as cold rolled steel sheets. These can also be electro-galvanized, hot-dip galvanized and/or zinc/nickel-coated steel sheets, for example. The composition is especially useful for bonding substrates having surfaces contaminated with oily substances, as good adhesion is attained despite such contamination.

Once cured, the adhesive compositions according to the present invention may be used as casting resins in the electrical or electronics industry or as die attach adhesives in electronics for bonding components to printed circuit boards. Further possible applications for the compositions are as matrix materials for composites, such as fiber-reinforced composites. One particularly preferred application for the adhesives according to the present invention is the formation of structural bonds in vehicle construction such as in hem flanges and the like.

In preferred embodiments, the epoxy adhesive is used to bond parts of automobiles or other vehicles. Such parts can be steel, coated steel, galvanized steel, aluminum, coated aluminum, plastic and filled plastic substrates. An application of particular interest is in bonding vehicle frame components to each other or to other components of the vehicle. The frame components are often metals such as cold rolled steel, galvanized metals, or aluminum. The components to be bonded to the frame components can also be metals as just described, or can be other metals, plastics, composite materials, and the like.

Assembled automotive frame members are usually coated with a coating material (e.g., paint) that requires a bake cure. The coating is typically baked at temperatures that may range from 140° C. to over 200° C., e.g., 177-204° C. for 10 to 20 minutes. In such cases, it is often convenient to apply the epoxy adhesive to the frame components, then apply the coating, and cure the epoxy adhesive at the same time the coating is baked and cured.

In some embodiments, curing is not performed immediately after the epoxy adhesive is applied. During such a delay before curing, the epoxy adhesive may be exposed to humid air at a temperature of up to about 40° C.

In some cases (the “open bead” case), the adhesive may be applied onto one of the substrates and left uncovered and exposed to ambient air for a period of time before the second substrate is brought into contact with the adhesive. In a manufacturing setting, the “open bead” case may occur, for example, when the adhesive is applied onto one of the substrates at or near the end of a working day or work week, but the next step of assembling the substrates together does not take place until work resumes on a subsequent work-day.

In other cases (the “closed bead” case), the second substrate is brought into contact with the adhesive, but the adhesive is left uncured and exposed to ambient air until a later time. Optionally, the resulting assembly may be pre-cured under conditions described herein. This case occurs in manufacturing settings wherein the step of marrying the substrates is performed, but the resulting assembly is not cured until a later time. The uncured or pre-cured assembly may be, for example, stored and/or transported prior to final curing. In such a case, the uncured or pre-cured adhesive may be exposed to humid air for a period of hours to months.

The adhesives of the invention are resistant to open bead and closed bead humid air exposure, as well as humid air exposure of the pre-cured adhesive, such that T-peel and other performance of the cured adhesive is maintained.

### Bonded Assemblies Comprising Cured Epoxy Adhesive Layers

The embodiments disclosed include the cured epoxy adhesive layers that have been prepared by thermally curing the liquid epoxy adhesive compositions set forth herein on a substrate preferably bonding two or more substrates together forming a bonded assembly. In preferred embodiments, the cured epoxy adhesive layer has a nominal thickness in a range of from 0.25 to 0.5 mm nominal, preferably about 0.25 mm.

These cured epoxy adhesive layers derive from curing the liquid epoxy adhesive compositions at temperatures in a range of from 140° C. to over 200° C., though in specific embodiments, the liquid compositions have been cured: (a) at a temperature of 160° C. for 10 minutes; or (b) at a temperature of 205° C. for 30 minutes.

Again, as set forth in the previous descriptions, the cured epoxy adhesive layers are adhered to substrates comprising a cold rolled steel (CRS), an electro galvanized steel (EZG), a hot dip galvanized steel (HDG), or a treated aluminum. The cured epoxy adhesive layer shows excellent adhesion to these substrates. In some embodiments, the cured epoxy adhesive layers exhibit a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019. These results are attainable without resorting to high concentrations of filler to achieve 100% cohesive mode of failure.

The adhesive compositions described herein exhibit high lap shear strength after exposure to humid conditions in the uncured state. As exemplified in the Examples, the cured epoxy adhesive layers:
(a) having been deposited on a first 1.5 mm HDG plate, exposed to 80% relative humidity in an uncured state for 72 hrs. at 23° C., positioned between the first 1.5 mm HDG plate and a second 1.5 mm HDG plate and pressed into a sandwich, cured at 175° C. for 25 min. and tested according to (ASTM D1002) exhibits lap shear strength of at least 28, 30, 32, 34, 36, or 38 MPa; and/or shows at least 90, 95, 97 98, 99 or 100% cohesive failure mode and/or
(b) having been humidity exposed according to the CKD protocol disclosed herein and tested according to (ASTM D1002) exhibits lap shear strength of at least 20, 21, 22, 23, 24, 26, 28, 30, 32, 34, 36, or 38 MPa; and/or shows at least 90, 95, 97 98, 99 or 100% cohesive failure mode and/or
(c) having been cured between two 0.8 mm thick cold rolled steel plates at 175° C. for 25 min exhibits a cleavage resistance under impact loading [impact wedge peel strength] of at least 20, 22, 24, 26, 28, 30, 22, 24, 26, 28, 30, 32, 34, 36, 38, 40, 42, 44, 46, 48, 50 or 52 N/mm when tested using the wedge impact method of ISO 11343.2019 at −40° C.; and/or
(d) having been cured between two 0.8 mm thick cold rolled steel plates at 175° C. for 25 min exhibits a cleavage resistance under impact loading [impact wedge peel strength] of at least 20, 22, 24, 26, 28, 30, 32, 34, 36, 38, 40, 42, 44, 46, 48, 50 or 52 N/mm when tested using the wedge impact method of ISO 11343.2019 at 23° C.; and/or
(e) having been cured between two 0.8 mm thick HDG plates at 175° C. for 25 min. provides adhesion between the plates sufficient when tested under T-peel conditions of ASTM D1876-08(2015)e1 to exhibit a T-peel strength of at least 4, 5, 6, 7, 8, 9, 10, 11, 12, 13, 14, or 15 N/mm; and/or
(f) having been cured between two 2.0 mm thick 5754 aluminum plates at 175° C. for 25 min provides adhesion between the plates sufficient when tested under T-peel conditions of ASTM D1876-08(2015)e1 to exhibit a T-peel strength of at least 5, 6, 7, 8, 9, 10, 11, 12, 13, 14, or 15 N/mm.
Specific Aspects of this Embodiment are provided in the Examples and are incorporated herein.

This disclosure embraces all articles of manufacturing comprising any of the liquid (pre- or partially cured) epoxy adhesive composition, as applied thereto (but not fully cured), as well as any cured epoxy adhesive layers adhered thereto. In certain embodiments, the article of manufacturing is an automobile, a home appliance, or a part thereof.

### Terms

In the present disclosure the singular forms “a.” “an,” and “the” include the plural reference, and reference to a particular numerical value includes at least that particular value, unless the context clearly indicates otherwise. Thus, for example, a reference to “a material” is a reference to at least one of such materials and/or equivalents thereof known to those skilled in the art, and so forth.

When a value is expressed as an approximation by use of the descriptor “about,” it will be understood that the particular value forms another embodiment. In general, the use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

The transitional terms “comprising.” “consisting essentially of,” and “consisting of” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C,” as separate embodiments.

Unless otherwise specified, compositional percentages are in terms of weight percent, relative to the weight of the material or composition.

The following examples are intended to complement, rather than displace or supersede, the previous descriptions.

### EXAMPLES

The following Examples provide experimental methods used to make and characterize the epoxy adhesives, their uncured properties, pre-cured, cure properties, cured properties and performance. While each example disclosed in the specification is considered to provide specific individual embodiments of compositions, methods of preparation and use, none of the Examples is to be considered limiting of the more general embodiments described herein.

In the following examples, efforts have been made to ensure accuracy with respect to numbers used (e.g., amounts, temperature, etc.), but some experimental error and deviation should be accounted for. Unless indicated otherwise, temperature is in degrees C., and pressure is at or near atmospheric.

### Exemplary Mixing Procedure:

Epoxy-based fracture toughened adhesive compositions were prepared according the following exemplary mixing conditions, unless otherwise stated herein: Diglycidyl ether of bisphenol (e.g. DGEBA and/or DGEBF) epoxy resin; epoxy novolac resin (poly[(phenyl glycidyl ether)-co-formaldehyde]; diluent; core shell rubber particles dispersed in DGEBA and/or DGEBF; a chelate modified glycidyl resin, if present; carboxyl-terminated butadiene (CTBN) adducted with DGEBA and/or DGEBF; variants had no, low or higher amounts of acrylonitrile and dissolved in novolac epoxy resin; any optional polyurethane toughener; a gamma-glycidoxypropyltrimethoxysilane coupling agent; and plasticizer were combined in a 100 g max Thinky cup and mixed under vacuum on a Thinky mixer at 2.000 rpm for 1.5 min. After mixing the resinous components, solid filler and thixotropic agents were added to the mixture and mixed at atmospheric pressure followed by 8.0 kPa vacuum mixing, for 1.5 min. each at 2.000 rpm. Additional desired adjuvants and additives were blended into the mixture. Thereafter, a 1K curative package, including dicyandiamide (DICY) and an accelerator, was added to the batch and mixed at atmospheric pressure followed by 8.0 kPa vacuum mixing, for 1.5 min. each at 2,000 rpm. Care was taken to ensure the batch was not heated to greater than 55.0° C.

### Testing

Unless indicated otherwise, T-peel testing was performed under T-peel conditions of ASTM D1876-08(2015)e1. CRS coupon (1×4 inch) thickness was 0.8 mm and Ferrocote 6130 lube was applied and Al coupon thickness was 2.0 mm and DC290 lube was applied. Metal coupons were bent at 90° 1 inch from the end of the coupon and were cleaned with 2-propanol and wiped with a paper towel, before being coated with lube on one side. The adhesive composition was then applied to the lubed side of the coupon along 3 inches of the specimen. Metal clips were used to hold the two coupons together during the cure cycle, typically baking at temperatures well in excess of ambient. Coupon/adhesive assemblies were cured as described below. Coupons for t-peel testing had 75 mm overlay and a width of 20 mm and were pulled using an Instrontester at a speed of 127 mm/min. The average load at plateau was used to calculate peel strength.

Coupons for impact peel testing having ISO 11343 test geometry (30 mm overlay, 20 mm width) were subjected to 90J impact load at a drop weight speed of 2 m/s. Impact peel strength was measured at average impact load at plateau using an Instron CEAST 9450 impact tester.

### Example 1. Wettability of Metal Surfaces Contaminated with Lubricant

The ability of a structural adhesive to absorb process oil or dry lubes on a substrate surface and then wet the substrate surface is important for adhesion.

ASTM D7490, the Standard Test Method for Measurement of the Surface Tension of Solid Coatings, Substrates and Pigments using Contact Angle Measurements and a Rame-Hart Goniometer were used to measure the surface tension (energy) of various substrates with and without process oil or dry lube. The results of water and diiodomethane (DIM) contact angles and calculated (ASTM D7490) surface energies are listed in Table 1.

TABLE 1
Contact angles and surface tension (energy) of hot
dipped galvanized (HDG), zinc magnesium aluminum
(ZnMgAl) and aluminum substrates, respectively.

| | | Contact | Contact | Surface |
|---|---|---|---|---|
| | Oil or | Angle, | Angle, | Energy |
| Substrate | Dry Lube | H₂O | DIM | (dyn/cm) |
| HDG | None | 89.0 | 54.1 | 32.5 |
| HDG | Fuchs 3802-39S | 67.4 | 39.1 | 45.0 |
| ZnMgAl | None | 89.5 | 55.3 | 31.8 |
| Al (5754-A951) | DC290 | 10.5 | 56.0 | 71.6 |
| Al (5754-A951) | None | 37.9 | 46.5 | 59.7 |

Fuchs 3802-39S: is a process oil; DC290: DryCote 290 is a dry lubricant containing mineral oil, waxes, ethoxylated alcohol and sulfonate salts.

The results in Table 1 show that hot dipped galvanized (HDG) and zinc magnesium aluminum (ZnMgAl) substrates have relatively low surface energies and are thus difficult to wet.

### Example 2. Comparative Examples

The oil absorption and wetting capabilities of toughened, crash durable structural epoxy adhesives on hot dipped galvanized (HDG) and zinc magnesium aluminum (ZnMgAl) substrates were examined. Five toughened, crash durable structural epoxy adhesives were made according to the formulations of Table 2, which recites amounts in weight percent.

TABLE 2
Comparative Toughened, Crash Durable Structural Epoxy Adhesives

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| Component | | | | | | |
| DGEBA | 15.17 | 32.10 | 31.90 | 30.70 | 31.30 | 31.96 |
| CSR dispersion in DGEBA; | 32.53 | 15.00 | 14.91 | 14.35 | 14.63 | 14.94 |
| 40 wt. % CSR | | | | | | |
| CTBN-DGEBF adduct | 7.61 | 7.61 | 7.56 | 7.28 | 7.42 | 7.58 |
| in novolac epoxy | | | | | | |
| Polyetheramine- | 10.27 | 10.27 | 10.21 | 9.82 | 10.01 | 10.23 |
| DGEBA adduct | | | | | | |
| PU 60 wt. % in DGEBA | 10.80 | 10.80 | 10.74 | 10.33 | 10.53 | 10.76 |
| GLYMO | 0.00 | 0.60 | 0.60 | 0.00 | 0.00 | 0.00 |
| CaO | 5.14 | 5.14 | 5.11 | 4.92 | 5.01 | 5.12 |
| Violet pigment | 0.03 | 0.03 | 0.03 | 0.03 | 0.03 | 0.03 |
| Calcium silicate | 5.14 | 5.14 | 5.11 | 4.92 | 5.01 | 5.12 |
| Hydrophobic fumed | 3.84 | 3.84 | 3.82 | 3.67 | 6.83 | 3.82 |
| silica | | | | | | |
| Hydrophobic CaCO₃ | 0.00 | 0.00 | 0.00 | 4.92 | 0.00 | 0.00 |
| precipitated | | | | | | |
| Mixed mineral | 0.00 | 0.00 | 0.60 | 0.00 | 0.00 | 0.00 |
| thixotrope (MMT) | | | | | | |
| Glass beads (GB) | 1.92 | 1.92 | 1.91 | 1.84 | 1.87 | 1.91 |
| 7.9% phosphorus | 2.39 | 2.39 | 2.38 | 2.29 | 2.33 | 2.38 |
| flame retardant (FR) | | | | | | |
| 83.8 wt. % paraffin | 0.00 | 0.00 | 0.00 | 0.00 | 0.00 | 1.00 |
| wax in epoxy diluent | | | | | | |
| Hollow glass | 0.90 | 0.90 | 0.89 | 0.86 | 0.88 | 0.90 |
| microspheres (HGM) | | | | | | |
| Modified urea | 0.84 | 0.84 | 0.83 | 0.80 | 0.82 | 0.84 |
| accelerator (MUA) | | | | | | |
| DICY | 3.42 | 3.42 | 3.40 | 3.27 | 3.33 | 3.41 |
| TOTAL | 100.00 | 100.00 | 100.00 | 100.00 | 100.00 | 100.00 |
| Concentration | | | | | | |
| DGEBA (wt. %) | 45.17 | 51.58 | 51.27 | 49.33 | 50.30 | 51.37 |
| Phenol novolac | 6.09 | 6.09 | 6.05 | 5.82 | 5.94 | 6.06 |
| epoxy (wt. %) | | | | | | |
| CTBN-DGEBF | 1.52 | 1.52 | 1.51 | 1.46 | 1.48 | 1.52 |
| adduct (wt. %) | | | | | | |
| CTBN-DGEBA | 0.00 | 0.00 | 0.00 | 0.00 | 0.00 | 0.00 |
| adduct (wt. %) | | | | | | |
| CTB/CTBN-DGEBA | 0.00 | 0.00 | 0.00 | 0.00 | 0.00 | 0.00 |
| adduct (wt. %) | | | | | | |
| CTB-DGEBA adduct (wt. %) | 0.00 | 0.00 | 0.00 | 0.00 | 0.00 | 0.00 |
| CSR (wt. %) | 13.01 | 6.00 | 5.96 | 5.74 | 5.85 | 5.98 |
| PU* (wt. %) | 6.48 | 6.48 | 6.44 | 6.20 | 6.32 | 6.46 |
| FR (wt. %) | 2.39 | 2.39 | 2.38 | 2.29 | 2.33 | 2.38 |
| DICY (wt. %) | 3.42 | 3.42 | 3.40 | 3.27 | 3.33 | 3.41 |

*The polyurethane toughening agent PU was characterized as containing a polytetramethylene glycol (PTMEG) backbone and was a polyurethane end-capped asymmetrically with an oxime and a hydrophobic mono-phenolic functional groups 60 wt. % in DEGBA.

Testing of oil uptake and adhesion was performed using the method illustrated in FIG. 1, which was adapted from a tack test disclosed in US 2020/0347279. The test was performed according to the following steps: Two 40×125 mm HDG metal coupons were used in each assembly. The HDG panel was coated with about 1.8 g/m² of a petroleum-based stamping oil that has a kinematic viscosity of 60 centistokes at 40° C. (Anticorit PL3802-39S from Fuchs Lubricants). Each adhesive sample was blended with less than 2 weight percent 0.2 mm glass beads to act as spacers. An adhesive layer is applied by drawing it down on one surface of the non-lubed coupon. The lubed HDG coupon surface was contacted with the adhesive layer on the non-lubed coupon, and the assembly squeezed under an applied weight of about 10 kg for 30 minutes at room temperature, the coupons were pulled apart with a metal implement. Both sides of the panel were visually inspected and graded based on the extent of adhesive oil uptake and wetting was observed.

A rating of “1” indicates 100% coverage after separation of the panels, while a rating of 2, 3, 4 and 5 indicate wetting of 95, 90, 75 and less than 75% of the panel after separation, respectively. It was found that Comp. Ex. 1 gave a wetting rating of “2”.

TABLE 3
Panel separation wetting rating for Comparative Examples 1-6.

| | Comp Example. | | | | | |
|---|---|---|---|---|---|---|
| | Comp. | Comp | Comp | Comp | Comp | Comp |
| | Ex. 1 | Ex. 2 | Ex. 3 | Ex. 4 | Ex. 5 | Ex. 6 |
| Wetting | 2 | 3 | 5 | 4 | 5 | 3 |
| Rating: | | | | | | |

Although Comp. Ex 1 was a highly fracture toughened epoxy structural adhesive containing a carboxyl-terminated butadiene-acrylonitrile (CTBN)/diglycidyl ether of bisphenol F (DGEBF) adduct and polyurethane pre-polymer, complete oil uptake and/or wetting of the HDG panel surfaces was not observed.

Modifications of the Comp. Ex. 1 formulation attempting to improve the thixotropy and hydrophobicity of the structural adhesive composition led to poorer oil absorption and/or wetting of the structural adhesive on the oily HDG surface. Specifically, standard thixotropic additives such as functionalized mixed mineral thixotropes (MMT, Ex. 3) and hydrophobic fumed silica (Ex. 5) led to poor oil uptake and/or poor wetting on the oily HDG surface of less than 75%. The resulting poor oil uptake and/or wetting of the adhesive onto the oily HDG surface corresponded to poor adhesive wash-off resistance in a laboratory simulation of E-coat process wash-off conditions, even though the adhesive yield stress or resistance to flow is typically increased by standard thixotropic agents.

### Example 3. Epoxy Adhesives with Reduced Acrylonitrile in CTBN/DGEBA Adduct

Six toughened, crash durable structural epoxy adhesives were made according to the formulations of Table 4, using adducts of DGEBA with different carboxyl-terminated butadienes, which provided lower or zero weight percent acrylonitrile monomer in the adduct, while CTBN-DGEBF amounts were held constant.

TABLE 4
Examples having improved oil absorption and substrate wetting via incorporation
of CTB/CTBN-DGEBA and CTB-DGEBA adducts, respectively.

| | Ex. 1 | Ex. 2 | Ex. 3 | Ex. 4 | Ex. 5 | Ex. 6 |
|---|---|---|---|---|---|---|
| Component (wt. %) | | | | | | |
| DGEBA | 27.70 | 22.70 | 12.70 | 29.05 | 25.40 | 18.10 |
| CSR dispersion in DGEBA; | 15.00 | 15.00 | 15.00 | 15.00 | 15.00 | 15.00 |
| 40 wt. % CSR | | | | | | |
| CTBN-DGEBF adduct in | 7.61 | 7.61 | 7.61 | 7.61 | 7.61 | 7.61 |
| novolac epoxy | | | | | | |
| Polyetheramine-DGEBA adduct | 10.27 | 10.27 | 10.27 | 10.27 | 10.27 | 10.27 |
| PU | 10.80 | 10.80 | 10.80 | 10.80 | 10.80 | 10.80 |
| CTBN-DGEBA adduct | 0.00 | 0.00 | 0.00 | 0.00 | 0.00 | 0.00 |
| CTB/CTBN-DGEBA adduct | 5.00 | 10.00 | 20.00 | 0.00 | 0.00 | 0.00 |
| CTB-DGEBA adduct | 0.00 | 0.00 | 0.00 | 3.65 | 7.30 | 14.60 |
| CaO | 5.14 | 5.14 | 5.14 | 5.14 | 5.14 | 5.14 |
| Violet | 0.03 | 0.03 | 0.03 | 0.03 | 0.03 | 0.03 |
| Calcium silicate | 5.14 | 5.14 | 5.14 | 5.14 | 5.14 | 5.14 |
| Hydrophobic fumed silica | 3.84 | 3.84 | 3.84 | 3.84 | 3.84 | 3.84 |
| GBs | 1.92 | 1.92 | 1.92 | 1.92 | 1.92 | 1.92 |
| 7.9% phosphorus flame | 2.39 | 2.39 | 2.39 | 2.39 | 2.39 | 2.39 |
| retardant (FR) | | | | | | |
| HGMs | 0.90 | 0.90 | 0.90 | 0.90 | 0.90 | 0.90 |
| MUA-1 | 0.00 | 0.00 | 0.00 | 0.00 | 0.00 | 0.00 |
| MUA-2 | 0.84 | 0.84 | 0.84 | 0.84 | 0.84 | 0.84 |
| DICY | 3.42 | 3.42 | 3.42 | 3.42 | 3.42 | 3.42 |
| TOTAL | 100.00 | 100.00 | 100.00 | 100.00 | 100.00 | 100.00 |
| Concentration | | | | | | |
| DGEBA (wt. %) | 50.73 | 49.28 | 46.38 | 50.72 | 49.26 | 46.34 |
| Phenol novolac epoxy (wt. %) | 6.09 | 6.09 | 6.09 | 6.09 | 6.09 | 6.09 |
| CTBN-DGEBF adduct (wt. %) | 1.52 | 1.52 | 1.52 | 1.52 | 1.52 | 1.52 |
| CTBN-DGEBA adduct (wt. %) | 0.00 | 0.00 | 0.00 | 0.00 | 0.00 | 0.00 |
| CTB/CTBN-DGEBA adduct (wt. %) | 1.45 | 2.90 | 5.80 | 0.00 | 0.00 | 0.00 |
| CTB-DGEBA adduct (wt. %) | 0.00 | 0.00 | 0.00 | 1.46 | 2.92 | 5.84 |
| CSR (wt. %) | 6.00 | 6.00 | 6.00 | 6.00 | 6.00 | 6.00 |
| PU (wt. %) | 6.48 | 6.48 | 6.48 | 6.48 | 6.48 | 6.48 |
| FR (wt. %) | 2.39 | 2.39 | 2.39 | 2.39 | 2.39 | 2.39 |
| DICY (wt. %) | 3.42 | 3.42 | 3.42 | 3.42 | 3.42 | 3.42 |

The Examples 1-6 were tested for oil uptake and adhesion according to the procedure of Example 2, with the results shown below in Table 5.

TABLE 5
Panel separation experiment wetting rating for Examples 1-6.

| Example: | Ex. 1 | Ex. 2 | Ex. 3 | Ex. 4 | Ex. 5 | Ex. 6 |
|---|---|---|---|---|---|---|
| Wetting Rating: | 3 | 2 | 1 | 1 | 1 | 2 |

Incorporation of carboxyl-terminated butadiene have low or zero weight percent acrylonitrile monomer in the diglycidyl ether of bisphenol A, (CTB)/CTBN/DGEBA or CTB/DGEBA respectively, showed improved oil uptake and/or surface wetting on HDG and ZnMgAl substrates (see Tables 4 and 5).

The wetting ratings in Table 5 show that higher concentrations of the CTB/CTBN/DGEBA adduct in the formulations were required to achieve complete oil uptake and wetting on the panel surface, as compared to formulations using the DGEBA adduct having 0 wt. % acrylonitrile monomer (ACN) (CTB/DGEBA adduct). Thus, the epoxy adhesive oil uptake and wetting correlated with ACN concentration in the toughening adduct.

### Example 4. Influence of Wetting and Thixotropic Agents on Epoxy Adhesives with Reduced Acrylonitrile in CTB/CTBN/DGEBA Adducts

Seven toughened, crash durable structural epoxy adhesives were made according to the formulations of Table 6, using CTB/CTBN adducts of DGEBA, the CTB component lowered the total weight percent acrylonitrile monomer in the adduct, and varying wetting and thixotropic agents.

TABLE 6
Influence of wetting and thixotropic agents on oil uptake and wash-off resistance.

| | Ex. 7 | Ex. 8 | Ex. 9 | Ex. 10 | Ex. 11 | Ex. 12 | Ex. 13 |
|---|---|---|---|---|---|---|---|
| Component | | | | | | | |
| DGEBA | 12.33 | 11.98 | 11.81 | 11.78 | 11.81 | 12.07 | 12.07 |
| CSR dispersion in | 14.56 | 14.15 | 13.95 | 13.91 | 13.95 | 14.27 | 14.25 |
| DGEBA; 40 wt. % CSR | | | | | | | |
| CTBN-DGEBF adduct | 7.39 | 7.18 | 7.08 | 7.06 | 7.08 | 7.24 | 7.23 |
| in novolac epoxy | | | | | | | |
| Polyetheramine-DGEBA | 9.97 | 9.69 | 9.55 | 9.53 | 9.55 | 9.77 | 9.75 |
| adduct | | | | | | | |
| PU | 10.49 | 10.19 | 10.05 | 10.02 | 10.05 | 10.28 | 10.26 |
| CTBN-DGEBA adduct | 0.00 | 0.00 | 0.00 | 0.00 | 0.00 | 0.00 | 0.00 |
| CTB/CTBN-DGEBA | 19.42 | 18.87 | 18.61 | 18.55 | 18.61 | 19.03 | 18.99 |
| adduct | | | | | | | |
| CTB-DGEBA adduct | 0.00 | 0.00 | 0.00 | 0.00 | 0.00 | 0.00 | 0.00 |
| Monofunctional epoxy | 0.00 | 2.83 | 2.79 | 2.78 | 2.79 | 0.29 | 0.28 |
| diluent | | | | | | | |
| Nonionic wetting agent | 0.00 | 0.00 | 0.00 | 0.28 | 0.00 | 0.29 | 0.28 |
| GLYMO | 0.00 | 0.00 | 0.00 | 0.00 | 0.00 | 0.00 | 0.19 |
| CaO | 4.99 | 4.85 | 4.78 | 4.77 | 4.78 | 4.89 | 4.88 |
| Violet | 0.03 | 0.03 | 0.03 | 0.03 | 0.03 | 0.03 | 0.03 |
| Calcium silicate | 4.99 | 4.85 | 4.78 | 4.77 | 4.78 | 4.89 | 4.88 |
| Hydrophobic fumed | 6.64 | 6.45 | 6.36 | 6.35 | 6.36 | 6.51 | 6.50 |
| silica | | | | | | | |
| Hydrophobic organic | 0.00 | 0.00 | 1.40 | 1.39 | 1.40 | 1.43 | 1.42 |
| thixotropic agent | | | | | | | |
| GBs | 1.86 | 1.81 | 1.79 | 1.78 | 1.79 | 1.83 | 1.82 |
| 7.9% phosphorus (FR) | 2.32 | 2.25 | 2.22 | 2.22 | 2.22 | 2.27 | 2.27 |
| HGMs | 0.87 | 0.85 | 0.84 | 0.83 | 0.84 | 0.86 | 0.85 |
| MUA-1 | 0.00 | 0.00 | 0.00 | 0.00 | 0.78 | 0.00 | 0.00 |
| MUA-2 | 0.82 | 0.79 | 0.78 | 0.78 | 0.00 | 0.80 | 0.80 |
| DICY | 3.32 | 3.23 | 3.18 | 3.17 | 3.18 | 3.25 | 3.25 |
| TOTAL | 100.00 | 100.00 | 100.00 | 100.00 | 100.00 | 100.00 | 100.00 |
| Concentration | | | | | | | |
| DGEBA (wt. %) | 45.03 | 43.76 | 43.14 | 43.02 | 43.14 | 44.12 | 44.06 |
| Phenol novolac epoxy | 5.91 | 5.74 | 5.66 | 5.65 | 5.66 | 5.79 | 5.78 |
| (wt. %) | | | | | | | |
| CTBN-DGEBF adduct | 1.48 | 1.44 | 1.42 | 1.41 | 1.42 | 1.45 | 1.45 |
| (wt. %) | | | | | | | |
| CTBN-DGEBA adduct | 0.00 | 0.00 | 0.00 | 0.00 | 0.00 | 0.00 | 0.00 |
| (wt. %) | | | | | | | |
| CTB/CTBN-DGEBA | 5.63 | 5.47 | 5.40 | 5.38 | 5.40 | 5.52 | 5.51 |
| adduct (wt. %) | | | | | | | |
| CTB-DGEBA adduct | 0.00 | 0.00 | 0.00 | 0.00 | 0.00 | 0.00 | 0.00 |
| (wt. %) | | | | | | | |
| CSR (wt. %) | 5.82 | 5.66 | 5.58 | 5.56 | 5.58 | 5.71 | 5.70 |
| PU (wt. %) | 6.29 | 6.11 | 6.03 | 6.01 | 6.03 | 6.17 | 6.16 |
| FR (wt. %) | 2.32 | 2.25 | 2.22 | 2.22 | 2.22 | 2.27 | 2.27 |
| DICY (wt. %) | 3.32 | 3.23 | 3.18 | 3.17 | 3.18 | 3.25 | 3.25 |

Examples 7-13 were tested for oil uptake and adhesion based on wetting rating testing according to the procedure of Example 2, with the results shown below in Table 7.

The adhesive wash-off resistance of each of Examples 7-13 was also evaluated. The wash-off testing was conducted by first applying a bead of an Example adhesive onto an HDG panel (200×40 mm) pre-coated with Fuchs Anticorit PL 3802-39S oil (1.8 g/m²) and then sandwiching the adhesive bead with a smaller panel (150×20 mm). Five punch rivets are then placed at regular intervals of 27 mm to connect the panels and squeeze out some of the adhesive from the underside of the smaller panel. The assembly was then rested for 24 hrs. and thereafter placed vertically on a rotatable rack in a water bath at 60° C. The exposed adhesive on the assembly was positioned in the bath to face the opposite side of the driveshaft and is thus exposed to flow during rotation. The assembly was then rotated at 160 RPM for 3 min, and then removed from the water bath. Each assembly was visually inspected for adhesive performance and graded as follows.

Wash-Off Rating: 1—no deformation; 2—minor deformation; 3—rupture with movement onto the upper panel; 4—significant wash-off and 5—complete separation.

TABLE 7
Panel separation experiment wetting rating, rheological properties
and wash-off resistance performance rating of Examples 7-13.

| Example: | Ex. 3 | Ex. 7 | Ex. 8 | Ex. 9 | Ex. 10 | Ex. 11 | Ex. 12 | Ex. 13 |
|---|---|---|---|---|---|---|---|---|
| Wetting Rating: | 1 | 2 | 1 | 2 | 1 | 1 | 2 | 1 |
| Viscosity (Pa*s): | 15.8 | 31.9 | ND | ND | ND | ND | 33.3 | 35.1 |
| Yield Stress (Pa): | ND | 841 | ND | ND | ND | ND | 843 | 918 |
| Wash-off Resistance | 5 | 1.5 | ND | ND | ND | ND | 1.5 | 1 |

*Yield stress was determined via an up/down linear flow sweep in a TA DHR-2 rheometer. The up/down shear rate range was 0 to 40 1/s. A Bingham analysis on the ‘up’ curve was used to determine the adhesive paste yield stress.

The examples in Table 6 and the corresponding panel separation, rheology and wash-off performance results in Table 7 show that incorporation of CTB/CTBN/DGEBA adducts containing lower amounts of acrylonitrile monomer in the adduct combined with increased concentration of hydrophobic fumed silica exhibited improved wash-off resistance while achieving complete coverage of panel surfaces under the panel separation experiment described in FIG. 1. For example, Comp. Ex. 5 having comparable amounts of hydrophobic fumed silica showed poor oil uptake and wetting, while Ex. 7 shows greater than 95% coverage and good wash-off resistance.

### Example 5. Exposure of Uncured Open Bead Adhesive to Humidity

Many crash durable structural adhesives (e.g. Comp. Ex. 1) exhibit a reduction in adhesion properties due to absorbed moisture in the uncured state. After exposure to humidity, full cure process temperatures cause the absorbed moisture to off-gas during cure, which result in interfacial failure and show evidence of a ‘foamy’ surface pattern on the coupon surface. To evaluate adhesion properties of embodiments of the invention subjected to moisture in the uncured state, Ex. 3, 7-13 and Comp. Ex. 1 were tested under the following humidity exposure conditions.

### Test Parameters:

Lap Sheer Strength (LSS) testing was performed on uniform sets of commercially available metal 1×4 inch test coupons as identified in Table 8 according to (ASTM D1002), the lap shear strength was measured to bond failure with a tensile machine at a pull rate of 10 to 20 mm/minute and expressed in MPa on an average of three specimens. The type of bond failure and any foaming was also observed and recorded as percent cohesive failure.

“Initial LSS testing” benchmarking adhesive performance was measured as follows: An uncured adhesive bead was applied across an oily lap shear coupon bond area on a first metal coupon. A second metal coupon of the same metal was joined with the first coupon in the bond area including the uncured adhesive bead between the coupons, forming a lap shear sample. The sample was then cured for 25 min. at 175° C., cooled to 23° C. and LSS tested.

“Open bead humidity LSS” adhesive performance was measured as follows: An uncured adhesive bead was applied across an oily lap shear coupon bond area on a first metal coupon, the coupon was not joined to a second coupon. The uncured adhesive bead remained as an open bead on the first coupon, which was then placed in a humidity chamber set to 23° C. and 80% relative humidity for 72 hrs. Thereafter, the humidity exposed uncured adhesive bead and first coupon were removed from the humidity chamber and a second metal coupon of the same metal was joined with the first coupon in the bond area including the uncured humidity exposed adhesive bead between the coupons, forming a lap shear sample, which was then cured for 25 min. at 175° C., cooled to 23° C. and LSS tested.

“CKD LSS” protocol: The Examples and Comparative Example in Table 8 were also evaluated under simulated “complete knock down” exposure conditions as follows. The CKD adhesive performance was measured as follows: 1) The lap shear specimens were assembled according to the “Initial testing” procedure, described above, but were not cured. 2) The lap shear specimens were heated at 173° C. for 13 min., resulting in a primary cure or pre-curing of the adhesive, not to full cure. 3) The lap shear specimens were then exposed to a humidity condition of 80% relative humidity at 45° C. for 35 days. 4) The lap shear specimens were removed from the humidity chamber and permitted to rest on a lab bench for 1 hr., followed by 5) a secondary cure step at 175° C. for 25 min., cooled to 23° C. and the subjected to LSS testing.

TABLE 8
Adhesion, open bead humidity, cured complete knock down (CKD)
humidity and impact properties of Ex. 3, 7-13 and Comp. Ex. 1.

| | Example: | | | | | | | | |
|---|---|---|---|---|---|---|---|---|---|
| | Comp | | | | | | | | |
| | Ex. 1 | Ex. 3 | Ex. 7 | Ex. 8 | Ex. 9 | Ex. 10 | Ex. 11 | Ex. 12 | Ex. 13 |
| Initial LSS (1.5 mm HDG) | 26.9 | 29.7 | 29.9 | 30.8 | 28.3 | 28.0 | 21.7 | 29.6 | 28.7 |
| (Mpa): | | | | | | | | | |
| % cohesive failure: | 100 | 100 | 100 | 100 | 100 | 100 | 100 | 100 | 100 |
| LSS after 3-day OB | 21.3 | 30.0 | 29.3 | 26.0 | 25.4 | 21.9 | 18.9 | 23.4 | 26.7 |
| exposure (1.5 mm HDG) | | | | | | | | | |
| (MPa): | | | | | | | | | |
| 3-day, uncured open bead | 50 | 90 | 90 | 80 | 50 | 50 | 50 | 50 | 80 |
| % cohesive failure: | | | | | | | | | |
| CKD exposure LSS (1.5 | 24.4 | 27.9 | 25.3 | 25.3 | 23.8 | 22.8 | 24.3 | 25.9 | 26.1 |
| mm HDG; 1 × 4″, 13 mm | | | | | | | | | |
| overlap), MPa: | | | | | | | | | |
| CKD exposure (1.5 mm | 50 | 75 | 50 | 60 | 60 | 50 | 90 | 90 | 90 |
| HDG; 1 × 4″ 13 mm overlap) | | | | | | | | | |
| % cohesive failure mode: | | | | | | | | | |
| Initial LSS (1.0 mm | 30.6 | 31.9 | ND | ND | ND | ND | ND | ND | 30.3 |
| ZnMgAl) (Mpa): | | | | | | | | | |
| % cohesive failure: | 50 | 100 | ND | ND | ND | ND | ND | ND | 100 |
| ISO 11343 Impact Wedge | 37.6 | 38.1 | 39.7 | ND | ND | ND | ND | 36.1 | 35.7 |
| Peel Strength (0.8 mm | | | | | | | | | |
| CRS) (N/mm) | | | | | | | | | |

In LSS testing, the data in Table 8 show that Ex. 3 and 7 have excellent lap shear strength retention and minimal foaming due to absorbed moisture, wherein >90% of the failure surface was cohesive after uncured, open bead humidity exposure testing. The incorporation of CTB/CTBN/DGEBA and CTB/DGEBA adducts resulted in increased hydrophobicity and improvements in uncured, open bead resistance to humidity exposure as shown in the LSS testing.

It was observed that the incorporation of a CTB/CTBN/DGEBA adduct and particular wetting agents led to a significant improvement in CKD failure mode. Therefore, improved oil uptake, wetting and improved interfacial adhesion led to improved CKD LSS properties. Cohesive failure performance improved relative to the Comparative Example 1 for all Examples: up to 90% cohesive failure was observed.

Impact Wedge Peel Strength testing was performed on ACT metal coupons as identified in Table 8 according to ISO 11343, with Examples 1 and 2 outperforming Comparative Example 1.

### Example 6. Effect of Varying Concentration of CTB/CTBN/DGEBA and CTBN-DGEBF Adducts

Additional investigation of low acrylonitrile CTB/CTBN/DGEBA adducts was conducted to better understand the effect of varying adduct structure and composition. Formulations were made as shown in Table 9. In Examples 14 and 15, the CTBN-DGEBF adduct pre-dissolved in novolac epoxy used in Comp. Ex. 1 was omitted and greater concentrations of the CTB/CTBN/DGEBA adduct were incorporated into the crash durable structural adhesive.

TABLE 9
Crash durable structural adhesive modified with varying
concentration of CTB/CTBN/DGEBA and CTBN-DGEBF adducts

| | Comp. | | |
|---|---|---|---|
| | Ex. 1 | Ex. 14 | Ex. 15 |
| Component | | | |
| DGEBA | 15.17 | 15.32 | 9.65 |
| CSR dispersion in DGEBA; 40 wt. % CSR | 32.53 | 32.79 | 32.07 |
| CTBN-DGEBF adduct in novolac epoxy | 7.61 | 0.00 | 0.00 |
| Polyetheramine-DGEBA adduct | 10.27 | 10.35 | 10.13 |
| PU | 10.80 | 10.88 | 10.65 |
| CTBN-DGEBA adduct | 0.00 | 0.00 | 0.00 |
| CTB/CTBN-DGEBA adduct | 0.00 | 7.66 | 14.99 |
| CaO | 5.14 | 5.18 | 5.07 |
| Violet | 0.03 | 0.03 | 0.03 |
| Calcium silicate | 5.14 | 5.18 | 5.07 |
| Hydrophobic fumed silica | 3.84 | 3.08 | 3.01 |
| GBs | 1.92 | 1.93 | 1.89 |
| 7.9% phosphorus (FR) | 2.39 | 2.41 | 2.36 |
| HGMs | 0.90 | 0.90 | 0.88 |
| Modified Urea | 0.84 | 0.84 | 0.82 |
| DICY | 3.42 | 3.45 | 3.38 |
| TOTAL | 100.00 | 100.00 | 100.00 |
| Concentration (wt. %) | | | |
| DGEBA (wt. %) | 45.17 | 50.99 | 49.87 |
| Phenol novolac epoxy (wt. %) | 6.09 | 0.00 | 0.00 |
| CTBN-DGEBF adduct (wt. %) | 1.52 | 0.00 | 0.00 |
| CTBN-DGEBA adduct (wt. %) | 0.00 | 0.00 | 0.00 |
| CTB/CTBN-DGEBA adduct (wt. %) | 0.00 | 2.22 | 4.35 |
| CTB-DGEBA adduct (wt. %) | 0.00 | 0.00 | 0.00 |
| CSR (wt. %) | 13.01 | 13.12 | 12.83 |
| PU (wt. %) | 6.48 | 6.53 | 6.39 |
| FR (wt. %) | 2.39 | 2.41 | 2.36 |
| DICY (wt. %) | 3.42 | 3.45 | 3.38 |

The crash durable structural adhesive of Table 9 were tested for Initial LSS performance according to the procedure described in Example 5. The LSS performance of Ex. 14 & 15 improved as compared to Comparative Example 1.

TABLE 10
Adhesion and impact properties of a crash durable
structural adhesive modified with varying concentration
of CTB/CTBN/DGEBA and CTBN-DGEBF adducts

| | Comp. | | |
|---|---|---|---|
| Test | Ex. 1 | Ex. 14 | Ex. 15 |
| Initial LSS (1.5 mm HDG), MPa: | 26.9 | 32.9 | 32.2 |
| % cohesive failure: | 100 | 100 | 100 |
| ISO 11343 IWP (−40° C.), 0.8 mm CRS, | 32.3 | 36.7 | 40.1 |
| N/mm: | | | |
| ISO 11343 IWP (−40° C.), 2.0 mm Al | 44.2 | 51.3 | 45.0 |
| 5754-A951-DC290, N/mm: | | | |

Cold impact wedge peel strength testing was also performed in accordance with ISO 11343 IWP on both CRS and aluminum test coupons. Surprisingly, cold impact wedge peel strength greater than 40 N/mm (specimens tested at −40° C.) was observed on both steel (0.8 mm oily CRS) and Al (2.0 mm 5754-A951-DC290) substrates after the incorporation of only 4.35 wt. % of the CTB/CTBN/DGEBA adduct. The desirable cohesive mode of fracture was also observed. The impact wedge peel strengths of Ex. 12 & 15 were significantly higher than OEM's standard requirements of 15 N/mm (−40 to +80° C.) and can allow the OEMs to further down-gauge steel substrate thickness for light-weighting and performance while maintaining crashworthiness.

### Example 7. Effect of Varying Concentration and Type of Toughening Agents on Epoxy Adhesives

Crash durable structural adhesives containing differing toughening agent chemistry, CTBN/DGEBA adduct or CTB/CTBN/DGEBA adduct, and one specimen made in the absence of carboxy terminated elastomer-epoxy adduct toughener were compared to analyze effects of presence of CTB in the backbone of CTBN/DGEBA adducts. A control composition having no toughening agent(s) and compositions containing 10 wt. % of CTBN/DGEBA or modified CTB/CTBN/DGEBA adduct were made according to Table 11.

TABLE 11
Crash durable structural adhesive compositions having
varying amounts of CTBN/DGEBA adduct and a low
acrylonitrile content CTB/CTBN/DGEBA adduct.

| | Comp. | Comp. | |
|---|---|---|---|
| | Ex. 7 | Ex. 8 | Ex. 16 |
| Component | | | |
| DGEBA | 72.79 | 50.49 | 40.94 |
| CSR dispersion in DGEBA; 40 wt. % | 0.00 | 0.00 | 0.00 |
| CSR | | | |
| CTBN-DGEBF adduct in novolac epoxy | 0.00 | 0.00 | 0.00 |
| Polyetheramine-DGEBA adduct | 0.00 | 0.00 | 0.00 |
| PU | 0.00 | 0.00 | 0.00 |
| CTBN-DGEBA adduct | 0.00 | 25.00 | 0.00 |
| CTB/CTBN-DGEBA adduct | 0.00 | 0.00 | 34.50 |
| CTB-DGEBA adduct | 0.00 | 0.00 | 0.00 |
| CaO | 5.68 | 5.12 | 5.13 |
| Violet | 0.03 | 0.03 | 0.03 |
| Calcium silicate | 5.68 | 5.12 | 5.13 |
| Hydrophobic fumed silica | 4.24 | 3.82 | 3.83 |
| GBs | 2.12 | 1.91 | 1.91 |
| 7.9% phosphorus (FR) | 2.65 | 2.38 | 2.39 |
| HGMs | 0.99 | 0.89 | 0.89 |
| Modified Urea | 0.92 | 0.83 | 0.83 |
| DICY | 4.90 | 4.41 | 4.42 |
| TOTAL | 100.00 | 100.00 | 100.00 |
| Concentration | | | |
| DGEBA (wt. %) | 72.79 | 65.49 | 65.44 |
| Phenol novolac epoxy (wt. %) | 0.00 | 0.00 | 0.00 |
| CTBN-DGEBF adduct (wt. %) | 0.00 | 0.00 | 0.00 |
| CTBN-DGEBA adduct (wt. %) | 0.00 | 10.00 | 0.00 |
| CTB/CTBN-DGEBA adduct (wt. %) | 0.00 | 0.00 | 10.01 |
| CTB-DGEBA adduct (wt. %) | 0.00 | 0.00 | 0.00 |
| CSR (wt. %) | 0.00 | 0.00 | 0.00 |
| PU (wt. %) | 0.00 | 0.00 | 0.00 |
| FR (wt. %) | 2.65 | 2.38 | 2.39 |
| DICY (wt. %) | 4.90 | 4.41 | 4.42 |
| Test Results | | | |
| Initial LSS (1.5 mm HDG), MPa: | 37.9 | 33.7 | 37.0 |
| % cohesive failure: | 50 | 50 | 100 |
| ISO 11343 IWP (23° C.), 0.8 mm CRS, | 0 | 0 | 10.5 |
| N/mm: | | | |
| T-peel strength (0.8 mm HDG, Fuchs oil), | 4.6 | 1.4 | 5.0 |
| N/mm: | | | |
| % cohesive failure: | 100 | 0 | Thin film* |
| T-peel strength Al (2.0 mm | 5.1 | 5.1 | 7.4 |
| 5754-A951-DC290), N/mm | | | |
| % cohesive failure: | 100 | 0 | Thin film* |

*Thin adhesive film coating remained on the bonded area of 1 specimen after joint failure, indicating 100% cohesive failure not achieved.

The crash durable structural adhesive of Table 11 were tested for Initial LSS performance according to the procedure described in Example 5. T-peel strength was measured on HDG and Aluminum according to ASTM-D1876. Impact wedge peel strength testing was performed in accordance with ISO 11343 IWP at room temperature. The direct comparison in the above formulations showed that presence of CTB/CTBN/DGEBA adduct led to improvements in adhesion, T-peel strength, and impact wedge peel strength, as compared to the standard CTBN/DGEBA adduct.

### Example 8. Influence of Hydrophobic Agents on Adhesives with Control CTBN/DGEBA Adducts

Increasing the hydrophobicity of the adhesive improves the adhesive's uncured, open bead humidity resistance (see Ex. 3 and 7). Therefore, since wax is hydrophobic, we also investigated incorporating a small concentration of a paraffin wax into a control uncured adhesive composition, made according to the Exemplary Mixing Procedure described herein. The following procedure was used:

The wax was melted and then blended with a low viscosity epoxy diluent and the warm mixture was incorporated, using a Thinky mixer under vacuum, into the uncured adhesive composition. No agglomeration of the wax in the adhesive was observed during and after incorporation into the uncured adhesive compositions formulated according to Table 12a.

TABLE 12a
Control epoxy adhesive compositions modified
with a paraffin wax containing additive

| | Comp. | | Comp. | Comp. | |
|---|---|---|---|---|---|
| Component | Ex. 1 | Ex. 17 | Ex. 9 | Ex. 10 | Ex. 18 |
| DGEBA | 15.17 | 15.02 | 31.70 | 31.70 | 31.70 |
| CSR | 32.53 | 32.21 | 15.00 | 15.00 | 15.00 |
| CTBN-DGEBF adduct | 7.61 | 7.53 | 7.61 | 7.61 | 7.61 |
| in novolac epoxy | | | | | |
| Polyetheramine- | 10.27 | 10.17 | 10.27 | 10.27 | 10.27 |
| DGEBA adduct | | | | | |
| PU | 10.80 | 10.69 | 10.80 | 10.80 | 10.80 |
| PU3 | 0.00 | 0.00 | 0.00 | 0.00 | 0.00 |
| GLYMO | 0.00 | 0.00 | 0.00 | 0.00 | 0.00 |
| Plasticizer | 0.00 | 0.00 | 0.00 | 0.00 | 0.00 |
| CaO | 5.14 | 5.09 | 5.14 | 5.14 | 5.14 |
| Violet | 0.03 | 0.03 | 0.03 | 0.03 | 0.03 |
| CaCO₃ | 0.00 | 0.00 | 0.00 | 0.00 | 0.00 |
| Calcium silicate | 5.14 | 5.09 | 5.14 | 5.14 | 5.14 |
| Hydrophobic fumed | 3.84 | 3.80 | 3.84 | 3.84 | 3.84 |
| silica | | | | | |
| GBs | 1.92 | 1.90 | 1.92 | 1.92 | 1.92 |
| MMT | 0.00 | 0.00 | 0.00 | 0.00 | 0.00 |
| ATH | 0.00 | 0.00 | 0.00 | 0.00 | 0.00 |
| Melamine | 0.00 | 0.00 | 0.00 | 0.00 | 0.00 |
| polyphosphate | | | | | |
| Melamine | 0.00 | 0.00 | 0.00 | 0.00 | 0.00 |
| 7.9% phosphorus flame | 2.39 | 2.37 | 2.39 | 2.39 | 2.39 |
| retardant (FR) | | | | | |
| 1239A paraffin wax | 0.00 | 0.99 | 0.00 | 0.00 | 1.00 |
| mixture; MP 60° C. | | | | | |
| 2281A paraffin wax | 0.00 | 0.00 | 1.00 | 0.00 | 0.00 |
| mixture; MP 50° C. | | | | | |
| 1230A paraffin wax | 0.00 | 0.00 | 0.00 | 1.00 | 0.00 |
| mixture; MP 55° C. | | | | | |
| HGMs | 0.90 | 0.89 | 0.90 | 0.90 | 0.90 |
| Modified Urea | 0.84 | 0.83 | 0.84 | 0.84 | 0.84 |
| DICY | 3.42 | 3.39 | 3.42 | 3.42 | 3.42 |
| TOTAL | 100.00 | 100.00 | 100.00 | 100.00 | 100.00 |
| DGEBA (wt. %) | 45.17 | 44.72 | 51.18 | 51.18 | 51.18 |
| Phenol novolac epoxy | 6.09 | 6.03 | 6.09 | 6.09 | 6.09 |
| (wt. %) | | | | | |
| CTBN (wt. %) | 1.52 | 1.51 | 1.52 | 1.52 | 1.52 |
| CSR (wt. %) | 13.01 | 12.88 | 6.00 | 6.00 | 6.00 |
| PU (wt. %) | 6.48 | 6.42 | 6.48 | 6.48 | 6.48 |
| FR (wt. %) | 2.39 | 2.37 | 2.39 | 2.39 | 2.39 |
| DICY (wt. %) | 3.42 | 3.39 | 3.42 | 3.42 | 3.42 |

Comp. Ex. 9, Comp. Ex. 10, Ex. 17 and Ex. 18 formulations included approx. 1.0 wt. % of a mixture containing 83.8 wt. % paraffin wax and 16.2 wt. % low viscosity epoxy diluent.

The Table 12a adhesives containing the paraffin wax were then applied to test coupons with the adhesive dispensed at 10° C. above the wax melting point and cooled to room temperature after application. As the adhesive bead cooled to below the wax melting point, a phase separated, hydrophobic barrier film formed on the outside of the adhesive bead. The hydrophobic barrier film was observed to encapsulate the adhesive bead and, without being bound by this theory, was thought to possibly reduce intrusion of moisture during uncured, open bead humidity exposure. Comp. Ex. 1, paraffin wax free adhesive composition was applied to test coupons according to the test procedures described herein, e.g. Example 5. The lap shear test samples were assembled and tested as described in Example 5 and the test results are shown in Table 12b.

TABLE 12b
Performance testing of epoxy adhesive compositions
modified with a paraffin wax containing additive

| | Comp. | | Comp. | Comp. | |
|---|---|---|---|---|---|
| | Ex. | Ex. | Ex. | Ex. | Ex. |
| Test | 1 | 17 | 9 | 10 | 18 |
| Initial LSS Al (2.0 mm 5754- | 23.1 | 21.9 | 20.6 | 21.7 | 21.6 |
| A951-DC290), MPa: | | | | | |
| % cohesive failure: | 100 | 100 | 100 | 100 | 100 |
| LSS after 3-day Open Bead | 17.4 | 21.3 | 16.4 | 17.7 | 20.7 |
| exposure Al (2.0 mm | | | | | |
| 5754-A951-DC290), MPa: | | | | | |
| % cohesive failure: | 50 | 100 | 50 | 50 | 100 |
| Initial LSS (1.5 mm HDG), | 36.1 | 35.1 | ND | ND | ND |
| MPa: | | | | | |
| % cohesive failure: | 100 | 100 | ND | ND | ND |
| LSS after 3-day Open Bead | 18.6 | 29.6 | ND | ND | ND |
| exposure (1.5 mm HDG), | | | | | |
| MPa: | | | | | |
| % cohesive failure: | 50 | 80 | ND | ND | ND |

The crash durable structural adhesive of Table 12a were tested for LSS and cohesive failure performance according to the procedure described in Example 5. Exs. 17 and 18 in Table 12b exhibited >95% lap shear strength (LSS) retention after uncured, open bead humidity exposure (humidity chamber set to 23° C.). Comp. Exs. 9 and 10 having lower MP paraffin than Ex. 17 and Ex. 18 showed that improvement in uncured, open bead humidity resistance appeared related to the melting point of the phase separating paraffin wax, where MP at least 37° C. greater than the humidity exposure temperature showed LSS equal or improved. The phase separated waxy barrier film also eliminated the ‘foamy’ failure mode, which is due to absorbed moisture from uncured, open bead humidity exposure.

### Example 9. CKD Moisture Analysis and Adhesion Failure Mode Analysis

Increased epoxy adhesive hydrophobicity and improved oil uptake and wetting led to improvements in CKD exposure properties, but the resulting failure mode was still not 100% cohesive, see Table 8, Ex. 13 above. Although the hydrophobicity of the epoxy structural adhesive was increased after incorporation of poly(butadiene) segments via CTB/CTBN/DGEBA adducts into the network backbone, the cured epoxy structural adhesives contain various polar and hydrophilic functional groups resulting from the chemical structure of the DGEBA resin, other chemistries in the formulation and products of the epoxy/amine and other polymerization reactions that occur during cure of the epoxy adhesive that are believed to contribute to moisture absorption by the cured epoxy structural adhesive during CKD exposure.

The diffusion of absorbed moisture then led to the undesirable failure mode in the CKD exposed epoxy structural adhesive, wherein the central portion of the lap shear specimens exhibited adhesive failure, while the outer portion exhibited cohesive failure. Specimens tested under CKD exposure conditions without the humidity exposure stage do not show this ‘inverted picture frame’ failure mode. For example, Comp. Ex. 1 exhibited 100% cohesive mode of failure under CKD conditions without humidity exposure and 50% adhesive failure under CKD conditions with humidity exposure.

Furthermore, differential scanning calorimetry (DSC) results shown in Table 13 on the cured adhesive removed from tested lap shear adherends (Ex. 12, see Tables 6-8) showed that the structural adhesive was greater than 90% cured after the initial CKD ‘pre-cure’ condition. The adhesive should be at least 80% cured to develop optimal fracture toughness and crashworthiness.

TABLE 13
Initial and post cure DSC results for Ex. 12.

| | Onset T | Exotherm Peak T | Exotherm | % |
|---|---|---|---|---|
| Cure Condition | (° C.) | (° C.) | (J/g) | Cure* |
| Initial/NA | 162.7 | 174.6 | 238.4 | N/A |
| 13 min at 173° C. | 200.4 | 226.9 | 7.3 | 96.9% |
| 25 min at 173° C. | 200.1 | 220.7 | 5.3 | 97.8% |
| 25 min at 183° C. | 201.8 | 222.6 | 3.9 | 98.4% |

*The percent of cure is calculated relative to the total initial exotherm.

In differential scanning calorimetry (DSC), approximately 12±1 mg of cured adhesive was removed from lap shear specimens and then placed into a TA Instruments Tzero Al hermetically sealed pan. The plan was then placed into a TA Instruments DSC Q100 for scanning at 10° C./min from 0 to 300° C. The residual exotherm peak was integrated to determine residual exotherm.

The extent of absorbed moisture was quantified via weight gain experiments on CKD lap shear specimens (HDG) and bulk dynamic mechanical analysis (DMA) specimens as a function of CKD humidity exposure time after the initial CKD pre-cure (173° C. for 13 min.) and after increased initial cure time and temperature (prior to humidity exposure). A graph showing moisture absorption of lap shear specimens during CKD humidity exposure over 35 days, for three different pre-cure parameters is shown in FIG. 2. The graph reveals non-Fickian diffusion of moisture into lap shear specimens made from Ex. 12 (see Tables 6-8) and HDG steel substrates. Surprisingly, an increase in moisture absorption as a function of higher initial cure (pre-cure) time and temperature was observed.

A graph showing moisture absorption of bulk epoxy adhesive DMA bars during CKD humidity exposure over 35 days, for three different pre-cure parameters is shown in FIG. 3. The bulk epoxy adhesive DMA bars show increased moisture absorption compared to the lap shear adherends due to the increased surface area exposed to humidity during environmental exposure.

Weight gain experiments showed that 65.4±8.4 and 53.0±0.5 wt. % of the total absorbed moisture (after the initial cure and humidity exposure) was lost from the lap shear and bulk specimens, respectively, after the secondary cure to complete the CKD exposure. The extent of plasticization due to absorbed moisture under CKD conditions was then determined via DMA. The DMA results in FIG. 4 show a significant decrease in glass transition temperature (Tg) resulting from plasticization due to absorbed moisture via CKD exposure. Interestingly, E′ at 23° C. increases after the secondary cure, even though the adhesive is >95% cured after the initial CKD cure condition (13 min. at 173° C., see DSC results in Table 13). The difference in E′ resulting from completion of the CKD exposure conditions decreases with increasing initial cure time and temperature.

The CKD exposed failure surfaces, moisture absorption results and DMA data show that the central portion of the adhesive bond had not been exposed to significant quantities of absorbed moisture and thus the adhesive properties of the central portion of the bond area were different than the outer, exposed epoxy adhesive nearer the edges of the lap shear specimens, where the adhesive has been plasticized due to absorbed moisture (see DMA results). Without being bound by a single theory, it is believed that residual absorbed moisture after the secondary cure may have reacted with CaO to form Ca(OH)₂, hydrolysed various chemistries in the formulation and/or hydrogen bonded with various components, among other interactions. The non-uniform moisture absorption resulted in two adhesive portions, with distinct properties within the same sample after CKD exposure, leading to interfacial adhesive failure in the central portion of the lap shear specimen bond. Thus, an optimum level of fracture toughness should exist to achieve cohesive failure after CKD exposure. The impact properties and crashworthiness of the adhesive should be maintained.

### Example 10: Adhesive Fracture Toughness Testing

Various compositions according to the invention were tested for T-peel strength, which is a measure of epoxy adhesive fracture toughness (or resistance to crack propagation) after controlling for substrate geometry and properties. These results, along with cured (CKD) and uncured environmental exposure data are shown in Table 14. Ex. 19 corresponds to Ex. 7 without the polyurethane pre-polymer PU.

TABLE 14
Influence of toughening agents on adhesion properties
after uncured and cured humidity exposure.

| | Ex. 19 | Ex. 20 | Ex. 21 |
|---|---|---|---|
| Component | | | |
| DGEBA | 17.80 | 10.05 | 7.88 |
| CSR dispersion in DGEBA; 40 wt. % CSR | 15.69 | 15.23 | 29.53 |
| CTBN-DGEBF adduct in novolac epoxy | 7.96 | 7.73 | 7.49 |
| Polyetheramine-DGEBA adduct | 10.74 | 10.43 | 10.11 |
| PU | 0.00 | 0.00 | 0.00 |
| CTBN-DGEBA adduct | 0.00 | 0.00 | 0.00 |
| CTB/CTBN-DGEBA adduct | 20.92 | 30.46 | 19.69 |
| CaO | 5.38 | 5.22 | 5.06 |
| Violet | 0.03 | 0.03 | 0.03 |
| Calcium silicate | 5.38 | 5.22 | 5.06 |
| Hydrophobic fumed silica | 7.15 | 6.95 | 6.73 |
| GBs | 1.05 | 1.02 | 0.98 |
| 7.9% phosphorus (FR) | 2.50 | 2.43 | 2.35 |
| HGMs | 0.94 | 0.91 | 0.89 |
| Modified Urea | 0.88 | 0.85 | 0.83 |
| DICY | 3.58 | 3.47 | 3.37 |
| TOTAL | 100.00 | 100.00 | 100.00 |
| Concentration | | | |
| DGEBA (wt. %) | 48.51 | 47.07 | 45.64 |
| Phenol novolac epoxy (wt. %) | 6.37 | 6.18 | 5.99 |
| CTBN-DGEBF adduct (wt. %) | 1.59 | 1.55 | 1.50 |
| CTBN-DGEBA adduct (wt. %) | 0.00 | 0.00 | 0.00 |
| CTB/CTBN-DGEBA adduct (wt. %) | 6.07 | 8.83 | 5.71 |
| CTB-DGEBA adduct (wt. %) | 0.00 | 0.00 | 0.00 |
| CSR (wt. %) | 6.28 | 6.09 | 11.81 |
| PU (wt. %) | 0.00 | 0.00 | 0.00 |
| FR (wt. %) | 2.50 | 2.43 | 2.35 |
| DICY (wt. %) | 3.58 | 3.47 | 3.37 |
| Test Results | | | |
| Initial LSS (1.5 mm HDG), MPa | 31.0 | 30.4 | 30.7 |
| % cohesive failure: | 100 | 100 | 100 |
| LSS after 3-day OB exposure (1.5 mm | 29.5 | 27.0 | 30.1 |
| HDG), MPa: | | | |
| 3-day, uncured open bead % cohesive | 95 | 95 | 100 |
| failure: | | | |
| CKD exposure LSS (1.5 mm HDG; 1 × 4″, | 29.1 | 28.9 | 30.7 |
| 13 mm overlap), MPa | | | |
| CKD exposure (1.5 mm HDG; 1 × 4″ 13 | 90 | 90 | 50 |
| mm overlap) % cohesive failure mode: | | | |
| ISO 11343 IWP (23° C.), 0.8 mm CRS, | 35.5 | 35.5 | 38.5 |
| N/mm: | | | |
| % cohesive failure | 100 | 100 | 100 |
| T-peel strength (0.8 mm HDG, Fuchs oil), | 7.6 | 7.1 | 10.9 |
| N/mm (ASTM: D1876): | | | |
| % cohesive failure: | 40 | 20 | 100 |

The crash durable structural adhesives of Table 14 were tested for LSS performance according to the procedure described in Example 5. T-peel strength was measured on HDG according to ASTM-D1876. Impact wedge peel strength testing was performed in accordance with ISO 11343 IWP at room temperature. Ex. 19 exhibited a 22.4% decrease in T-peel strength, showed significant improvements in uncured, open bead humidity resistance and CKD strength retention. Ex. 20 showed that a 45.5% increase in the CTB/CTBN/DGEBA adduct concentration, while holding CSR particle concentration constant, did not increase the fracture toughness significantly. However, in Ex. 21 an 88.1 wt. % increase in CSR particle concentration resulted in a 43.4% increase in T-peel strength, excellent strength retention after uncured, open bead humidity resistance and CKD exposure. However, the increase in CSR particle concentration led to poor CKD failure mode.

### Example 11: Adhesive Fracture Toughness Testing

Various compositions according to the invention, with different solid additives, were formulated according to Table 15 and were tested for lap shear strength and T-peel strength, which is a measure of epoxy adhesive fracture toughness (or resistance to crack propagation) after controlling for substrate geometry and properties.

TABLE 15
Compositions exhibiting 100% cohesive
mode of failure after CKD exposure.

| | Ex. 22 | Ex. 23 | Ex. 24 | Ex. 25 |
|---|---|---|---|---|
| Component | | | | |
| DGEBA | 18.19 | 8.16 | 0.00 | 12.32 |
| CSR dispersion in DGEBA; 40 wt. | 30.29 | 30.26 | 26.84 | 14.53 |
| % CSR | | | | |
| CTBN-DGEBF adduct in novolac | 7.68 | 7.68 | 6.81 | 7.37 |
| epoxy | | | | |
| Polyetheramine-DGEBA adduct | 10.37 | 10.36 | 9.19 | 9.95 |
| PU | 0.00 | 0.00 | 0.00 | 10.47 |
| CTBN-DGEBA adduct | 0.00 | 0.00 | 0.00 | 0.00 |
| CTB/CTBN-DGEBA adduct | 0.00 | 0.00 | 0.00 | 19.38 |
| CTB-DGEBA adduct | 7.32 | 7.31 | 6.49 | 0.00 |
| GLYMO | 0.20 | 0.20 | 0.18 | 0.00 |
| CaO | 5.19 | 5.19 | 4.60 | 4.98 |
| Violet | 0.03 | 0.03 | 0.03 | 0.03 |
| Calcium silicate | 5.19 | 5.19 | 4.60 | 4.98 |
| Hydrophobic fumed silica | 6.91 | 6.90 | 6.12 | 6.63 |
| 1 wt. % GO/POSS dispersion in | 0.00 | 10.09 | 26.81 | 0.00 |
| DGEBA | | | | |
| Expanding thermoplastic | 0.00 | 0.00 | 0.00 | 0.19 |
| microspheres | | | | |
| GBs | 1.01 | 1.01 | 0.89 | 1.86 |
| 7.9% phosphorus flame retardant | 2.41 | 2.41 | 2.14 | 2.32 |
| (FR) | | | | |
| 83.8 wt. % paraffin wax in epoxy | 0.00 | 0.00 | 0.00 | 0.00 |
| diluent | | | | |
| HGMs | 0.91 | 0.91 | 0.81 | 0.87 |
| Modified Urea | 0.85 | 0.85 | 0.75 | 0.81 |
| DICY | 3.45 | 3.45 | 3.74 | 3.31 |
| TOTAL | 100.00 | 100.00 | 100.00 | 100.00 |
| Concentration | | | | |
| DGEBA (wt. %) | 46.98 | 46.91 | 52.05 | 44.96 |
| Phenol novolac epoxy (wt. %) | 6.14 | 6.14 | 5.45 | 5.90 |
| CTBN-DGEBF adduct (wt. %) | 1.54 | 1.54 | 1.36 | 1.47 |
| CTBN-DGEBA adduct (wt. %) | 0.00 | 0.00 | 0.00 | 0.00 |
| CTB/CTBN-DGEBA adduct (wt. | 0.00 | 0.00 | 0.00 | 5.62 |
| %) | | | | |
| CTB-DGEBA adduct (wt. %) | 2.93 | 2.92 | 2.60 | 0.00 |
| CSR (wt. %) | 12.12 | 12.10 | 10.74 | 5.81 |
| PU (wt. %) | 0.00 | 0.00 | 0.00 | 6.28 |
| FR (wt. %) | 2.41 | 2.41 | 2.14 | 2.32 |
| DICY (wt. %) | 3.45 | 3.45 | 3.74 | 3.31 |
| Test Results | | | | |
| Initial LSS (1.5 mm HDG), MPa: | 36.4 | 36.9 | 37.7 | 30.4 |
| % cohesive failure: | 100 | 100 | 100 | 100 |
| CKD exposure LSS (1.5 mm | 32.3 | 33.0 | 35.6 | 27.6 |
| HDG; 1 × 4″, 13 mm overlap), | | | | |
| MPa: | | | | |
| CKD exposure (1.5 mm HDG; 1 × | 95 | 95 | 100 | 100 |
| 4″ 13 mm overlap) % cohesive | | | | |
| failure mode: | | | | |
| ISO 11343 IWP (23° C.), 0.8 mm | 40.9 | 38.1 | 34.1 | 40.4 |
| CRS, N/mm: | | | | |

The crash durable structural adhesives of Table 15 were tested for Initial LSS performance according to the procedure described in Example 5. Impact wedge peel strength testing was performed in accordance with ISO 11343 IWP at room temperature. An impact wedge peel strength >30 N/mm was maintained. Larger CKD specimens (45 mm width) were used for CKD exposure LSS testing which exhibited increased moisture absorption (see FIGS. 2 and 3 comparing 1×4″ lap shear and bulk specimens, respectively) due to increased exposed adhesive surface area during cured humidity exposure.

Surprisingly, a small concentration of graphene oxide and polyhedral oligomeric silsesquioxane (POSS) improved both the CKD failure mode and CKD strength properties. Table 15 shows the influence of the CTB/DGEBA adduct having 0 wt. % ACN and an increasing concentration of GO/POSS on the CKD strength retention and failure mode. A 100% cohesive failure mode was observed after incorporation of only about 0.3 wt. % GO/POSS mixture. Furthermore, the impact properties of the structural adhesive compositions were not negatively influenced by incorporation of the GO/POSS mixture.

Ex. 25, containing 0.19 wt. % expanding agent, exhibited a 100% cohesive failure mode after CKD exposure with maintained impact properties. This work shows that various nanomaterials and other fillers can be used when combined with hydrophobic, low, or 0 wt. % ACN CTB/CTBN/DGEBA adducts to improve CKD properties and maintain good oil uptake, wetting, adhesion and impact properties.

### Example 12: Effect of Solid Epoxy Resin

Various compositions according to the invention, with different solid additives, were formulated according to Table 16.

TABLE 16
Improvements in CKD properties on 45 mm
wide specimens with solid additives.

| | Ex. 26 | Ex. 27 | Ex. 28 | Ex. 29 |
|---|---|---|---|---|
| Component | | | | |
| DGEBA | 16.36 | 13.08 | 13.08 | 9.47 |
| DGEBA solid | 0 | 3.27 | 3.27 | 3.04 |
| CSR dispersion in DGEBA; 40 wt. | 14.41 | 14.41 | 14.41 | 17.85 |
| % CSR | | | | |
| CTBN-DGEBF adduct in novolac | 10.57 | 10.57 | 10.57 | 9.82 |
| epoxy | | | | |
| Polyetheramine-DGEBA adduct | 9.87 | 9.87 | 9.87 | 9.17 |
| PU | 0 | 0 | 0 | 0 |
| CTBN-DGEBA adduct | 0 | 0 | 0 | 0 |
| CTB/CTBN-DGEBA adduct | 19.22 | 19.22 | 19.22 | 17.85 |
| CTB-DGEBA adduct | 0 | 0 | 0 | 0 |
| GLYMO | 0.29 | 0.29 | 0.29 | 0.27 |
| CaO | 8.65 | 8.65 | 8.65 | 8.03 |
| Violet | 0.03 | 0.03 | 0.03 | 0.03 |
| Calcium silicate | 4.94 | 4.94 | 4.94 | 4.59 |
| Hydrophobic fumed silica | 6.25 | 6.25 | 7.21 | 7.14 |
| Hydrophobic organic thixotropic | 0.96 | 0.96 | 0.96 | 0.89 |
| agent | | | | |
| Precipitated CaCO₃ | 0 | 0 | 0 | 4.02 |
| 1 wt. % GO/POSS dispersion | 0 | 0 | 0 | 0 |
| Expanding thermoplastic | 0 | 0 | 0 | 0 |
| microspheres | | | | |
| GBs | 0.96 | 0.96 | 0.96 | 0.89 |
| 7.9% phosphorus flame retardant | 2.30 | 2.3 | 2.3 | 2.13 |
| (FR) | | | | |
| 83.8 wt. % paraffin wax in epoxy | 0 | 0 | 0 | 0 |
| diluent | | | | |
| HGMs | 0.86 | 0.86 | 0.86 | 0.80 |
| Mica | 0.24 | 0.24 | 0.24 | 0.22 |
| Modified Urea | 0.81 | 0.81 | 0.81 | 0.75 |
| DICY | 3.29 | 3.29 | 3.29 | 3.05 |
| TOTAL | 100.00 | 100.00 | 100.96 | 100.00 |
| Concentration | | | | |
| DGEBA (wt. %) | 44.46 | 41.3 | 40.9 | 38.3 |
| Solid epoxy (wt. %) | 0 | 3.27 | 3.20 | 3.04 |
| Phenol novolac epoxy (wt. %) | 8.46 | 8.46 | 8.40 | 7.85 |
| CTBN-DGEBF adduct (wt. %) | 2.11 | 2.11 | 2.09 | 1.96 |
| CTBN-DGEBA adduct (wt. %) | 0 | 0 | 0 | 0 |
| CTB/CTBN-DGEBA adduct (wt. | 5.57 | 5.57 | 5.52 | 5.18 |
| %) | | | | |
| CTB-DGEBA adduct (wt. %) | 0 | 0 | 0 | 0 |
| CSR (wt. %) | 5.77 | 5.77 | 5.71 | 7.14 |
| PU (wt. %) | 0 | 0 | 0 | 0 |
| FR (wt. %) | 2.30 | 2.30 | 2.27 | 2.13 |
| DICY (wt. %) | 3.29 | 3.29 | 3.26 | 3.05 |
| Test Results | | | | |
| Adhesive Yield Stress (yield onset | 963.4 | 563.6 | 760.2 | 1762.9 |
| via stress ramp, 60° C.) Pa | | | | |
| Wash-off Resistance | 3.7 | ND | 2.7 | 1 |
| Initial LSS (1.3 mm HDG, 1 × 4″, | 33.6 | 33.3 | ND | 31.1 |
| 13 mm overlap), MPa | | | | |
| LSS after 3-day OB exposure (1.5 | 32.7 | 31.1 | ND | 32.2 |
| mm HDG), MPa | | | | |
| 3-day, uncured open bead % | 95 | 85 | ND | 80 |
| cohesive failure (remainder, thin | | | | |
| film' adhesion) | | | | |
| % Interfacial Adhesion Failure Due | 0 | 0 | ND | 0 |
| to Absorbed Moisture | | | | |
| CKD exposure LSS (1.3 mm | 21.7 | 22.1 | ND | 20.5 |
| HDG; 1.77 × 4″, 13 mm overlap), | | | | |
| MPa | | | | |
| CKD exposure (1.3 mm HDG; | 70 | 100 | ND | 92 |
| 1.77 × 4″ 13 mm overlap) % | | | | |
| cohesive failure mode | | | | |
| ISO 11343 IWP (23° C.), 0.8 mm | 28.8 | 26.1 | ND | 26.6 |
| CRS, N/mm | | | | |

The crash durable structural adhesives of Table 16 were tested for adhesive yield stress using a TA DHR-2 rheometer with a method having a linear stress ramp at 60° C. The yield stress is the ‘onset’ stress for the transition from linear to non-linear behaviour on a stress vs. shear rate plot. The adhesives were also tested for wash-off resistance and LSS performance according to the procedures described in Examples 4 and 5, respectively. No interfacial adhesion failure due to absorbed moisture was observed. Impact wedge peel strength testing was performed in accordance with ISO 11343 IWP at room temperature. Ex. 26-28 in Table 16 show additional improvements in CKD properties including failure mode via incorporation of solid epoxy resin. Solid epoxy resin increased the strain to failure of the epoxy adhesive in the interphase between the bulk epoxy and the metallic adherend, thereby improving interfacial adhesion leading to additional improvements in cured humidity resistance. Ex. 28, having a combination of solid epoxy resin, hydrophobic surface treated fumed silica and precipitated calcium carbonate showed good adhesion and uncured humidity resistance and improved adhesive yield stress, which correlates with improvements in wash-off resistance. Inclusion of CTB/CTBN facilitated oil absorption and metal substrate surface wetting by the adhesive formulations of Table 16, which also appeared to work with the fillers contributing to uncured and cured property improvements.

As those skilled in the art will appreciate, numerous modifications and variations of the present invention are possible in light of these teachings, and all such are contemplated hereby. All references cited herein are incorporated by reference herein, at least for their teachings in the context presented.

What is claimed:

1. A liquid epoxy adhesive composition comprising:
(a) at least one epoxy resin;
(b) one or more carboxyl-terminated butadiene rubbers;
(c) rubber particles, optionally core-shell rubber particles (CSR) and/or particles of size 500 nm or less;
(d) optional one or more blocked polyurethane toughening agents;
(e) at least one heat-activated latent curing agent comprising DICY;
(f) at least one accelerator different from the curing agent;
wherein (b) comprises at least one carboxyl-terminated butadiene homopolymer (CTB) and at least one carboxyl-terminated butadiene acrylonitrile copolymer (CTBN).

2. The liquid epoxy adhesive composition of claim 1 wherein the components (a)-(f) comprise:
(a) one or more diglycidyl ether of a bisphenol-A (DGEBA) epoxy resins or bisphenol-F (DGEBF) epoxy resins, present in a range of from 20 wt. % to 80 wt. %;
(b) at least two selected from a carboxyl-terminated butadiene homopolymer (CTB)-epoxy adducts, a carboxyl-terminated butadiene acrylonitrile copolymer (CTBN)-epoxy adduct, or an adduct of carboxyl-terminated butadiene homopolymer (CTB) and carboxyl-terminated butadiene acrylonitrile copolymer (CTBN) and epoxy, each independently present in a range of from 1 wt. % to 30 wt. %;
(c) core shell rubber (CSR) particles, present in a range of from 5 wt. % to 40 wt. %;
(d) optional one or more blocked polyurethane toughening agents, present in a range of from 0 wt. % to 20 wt. %;
(e) one or more dicyandiamides (DICY), present in a range of from 2 wt. % to 7 wt. %;
(f) one or more urea-based accelerator, present in a range of from 0.3 wt. % to 2.0 wt. %;
(g) one or more filler, present in a range of from 0 wt. % to 35 wt. %;
(h) one or more phenol novolac epoxies, present in a range of from 1 wt. % to 20 wt. %;
(i) one or more flame retardants, present in a range of from 0 wt. % to 35 wt. %;
(j) one or more polyetheramine flexibilizer, present in a range of from 3 wt. % to 30 wt. %; and
(k) one or more thixotropic agents, present in a range of from 0 wt. % to 25 wt. %;
wherein the wt. % of each component is relative to the total weight of the composition and the total amount of the components does not exceed 100 wt. %.

3. The liquid epoxy adhesive composition of claim 2, wherein the one or more of diglycidyl ether of the bisphenol-A (DGEBA) epoxy resin has an Epoxy Equivalent Weight (EEW) in a range of from 180 to 195, where
$$EEW = \frac{MW epoxy resin}{Number ( \# ) of epoxy groups} .$$

4. The liquid epoxy adhesive composition of claim 1, wherein the at least one carboxyl-terminated butadiene acrylonitrile (CTBN) is adducted with DGEBF, DGEBA or both adducts are present.

5. The liquid epoxy adhesive composition of claim 1, wherein the one or more carboxyl-terminated butadiene polymers (CTB) is adducted with DGEBF, DGEBA or both adducts are present.

6. The liquid epoxy adhesive composition of claim 1, wherein the at least one carboxyl-terminated butadiene acrylonitrile (CTBN) is adducted with carboxyl-terminated butadiene homopolymer (CTB) and one or more of DGEBF and DGEBA.

7. The liquid epoxy adhesive composition of claim 1, wherein the core shell rubber (CSR) particles:
(a) are monomodally or bimodally dispersed;
(b) have a mean particle size of 50 nm to 500 nm;
(c) have a core comprising polybutadiene, a butadiene/styrene copolymer, or an acrylic polymer or copolymer; and/or
(d) are dispersed in DGEBA epoxy resin.

8. The liquid epoxy adhesive composition of claim 1, wherein the optional one or more blocked polyurethane toughening agent is present and comprises a polytetramethylene glycol (poly-THF or PTMEG), having an equivalent molecular weight in a range of from 2000-5000 Daltons; wherein the polyalkylene glycol segment optionally is flanked at both ends by polyalkylene (extender) segments; and
the polyurethane toughening agent is end capped at both ends, wherein each end cap is independently a substituted phenol or bisphenol (or a hydroxyheteroaryl analog), an amine, methacryl, acetoxy, oxime, and/or pyrazole.

9. The liquid epoxy adhesive composition of claim 1, wherein the one or more dicyandiamide (DICY) is a micronized dicyandiamide, and the accelerator is or comprises urea, a guanidine, or a substituted urea, wherein d90 of the micronized dicyandiamide has a particle diameter of 40 microns or less.

10. The liquid epoxy adhesive composition of claim 1, wherein the one or more flame retardant present, and when presents comprises one or more of aluminum trihydrate (ATH), an ammonium polyphosphate, melamine, melamine polyphosphate, a phosphonate ester (e.g., diethyl bis(hydroxyethyl) aminomethyl phosphonate, a halogen-free phosphorus ester, or any combination of an unsubstituted, mono-, di-, or tri-butylated phenyl phosphates.

11. The liquid epoxy adhesive composition of claim 1, wherein the one or more filler comprises one or more of calcium carbonate, calcium oxide, calcium silicate, aluminosilicate, organophilic phyllosilicates, naturally occurring clays such as bentonite, wollastonite or kaolin glass, silica, polyhedral oligomeric silsesquioxane (POSS), mica, talc, optionally functionalized graphite, optionally functionalized graphene, microspheres (polymeric or glass beads), or hollow glass microspheres, chopped or milled fibers [e.g., carbon, glass, or aramid], pigments, zeolites (natural or synthetic), or thermoplastic fillers.

12. The liquid epoxy adhesive composition of claim 1, wherein the one or more accelerators different from the curing agent is or comprises a micronized urea-based accelerator, wherein the urea-based accelerator is one or more of urea, substituted urea having one, two, three, or four alkyl groups or a methylene bridged bis(phenylurea) N-substituted with one, two, three, or four alkyl groups, and/or wherein the accelerator becomes activated in a temperature range of 100° C. to 180° C.

13. The liquid epoxy adhesive composition of claim 1, wherein the one or more polyetheramine flexibilizer is or comprises an amine end-capped polyalkylene glycol, having an average weight averaged molecular weight in a range of from about 1000 to 3000 Daltons, the polyetheramine flexibilizer optionally comprising a DGEBA adduct.

14. A method of preparing the liquid epoxy adhesive composition of claim 1, the method comprising steps, at a temperature less than the activation energy of the final desired composition, of: 1) combining liquid components, 2) mixing solid components, except curing agent and accelerator, into the combination of step 1), and 3) incorporating curing agent and accelerator into the mixture.

15. A method of making a bonded assembly comprising steps of: applying the epoxy adhesive composition of claim 1 on a first surface; contacting at least one second surface with the epoxy adhesive composition on the first surface forming an uncured assembly; and curing the epoxy adhesive composition in contact with the first and second surfaces to prepare a bonded assembly.

16. The method of claim 15 further comprising a pre-curing step after the contacting step and prior to the curing step, said pre-curing step comprising heating the epoxy adhesive in the uncured assembly for a time and at a temperature resulting in at least 50% and less than 99% cure of the epoxy adhesive, as measured by differential scanning calorimetry.

17. The bonded assembly of claim 15 prepared by thermally curing the epoxy adhesive composition at a temperature in a range of from 140° C. to 220° C.

18. The bonded assembly of claim 17, which when cured exhibits a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019.

19. An article of manufacturing comprising the epoxy adhesive composition of claim 1, as applied on at least one surface of the article and uncured; or cured on the at least on surface of the article, wherein the article of manufacturing is optionally automobile or a part thereof.
